(19) United States
(12) Patent Application Publication
(10) Pub. No.: US 2021/0024747 A1
(43) Pub. Date: Jan. 28, 2021

(54) ADDITIVE MANUFACTURING COMPOSITIONS

(71) Applicant: DuPont Polymers, Inc., Wilmington, DE (US)

(72) Inventors: Berardino D'Achille, ARDMORE, PA (US); Yanyan Cao, WILMINGTON, DE (US); Lynda Kaye Johnson, WILMINGTON, DE (US); Jennifer Leigh Thompson, NEWARK, DE (US); Kai Qi, WILMINGTON, DE (US); Ting Wang, SHANGHAI (CN); Thomas E. Lovelace, PORT DEPOSIT, MD (US); Robert Desmond, NEWARK, DE (US); Mario A. Martinez Farias, WILMINGTON, DE (US)

(21) Appl. No.: 17/043,010

(22) PCT Filed: Apr. 5, 2019
(86) PCT No.: PCT/US19/26013

§ 371 Date: Sep. 29, 2020

Related U.S. Application Data
(60) Provisional application No. 62/653,733, filed on Apr. 6, 2018.

(51) Int. Cl. C08L 77/06; B33Y 70/00; B33Y 80/00

(52) U.S. Cl. CPC C08L 77/06; C08L 2205/025; B33Y 80/00; B33Y 70/00

(57) ABSTRACT

Disclosed are additive manufacturing compositions comprising: A) 100 to 30 weight percent of a polyamide composition comprising: a) 95 to 5 weight percent of at least one semi-crystalline copolyamide having a melting point, said semi-crystalline copolyamide comprising: i) 5 to 40 mole percent aromatic repeat units derived from one or more aromatic dicarboxylic acids with 8 to 20 carbon atoms and at least one aliphatic diamine with 4 to 20 carbon atoms; and ii) 60 to 95 mole percent aliphatic repeat units derived from one or more aliphatic dicarboxylic acids with 6 to 20 carbon atoms and one or more aliphatic diamines with 4 to 20 carbon atoms; b) 5 to 95 weight percent of at least one amorphous copolyamide comprising: iii) 60 to 90 mole percent aromatic repeat units derived from isophthalic acid and at least one aliphatic diamine with 4 to 20 carbon atoms; and iv) 10 to 40 mole percent aromatic repeat units derived from terephthalic acid and at least one aliphatic diamine with 4 to 20 carbon atoms; and B) 0 to 70 weight percent of at least one additive. These compositions provide 3D printed articles having improved physical properties.

### OVERVIEW

Disclosed herein are additive manufacturing (AM) compositions of use in preparing 3D printed articles using material extrusion additive manufacturing processes. These AM compositions may be used to prepare filaments and pellets, which may be used in fused filament fabrication and pellet additive manufacturing processes, respectively. Also disclosed herein are 3D printed articles prepared by such processes.

Additive manufacturing (AM), also known as 3-dimensional (3D) printing, is used to print or otherwise manufacture 3D parts from digital representations of the 3D parts (e.g., AMF and STL format files) using one or more additive manufacturing techniques. Successive layers of a composition are deposited and fused together to produce an article having a defined shape. By the term “fused” is meant that the successive layers adhere to one another. Examples of commercially available additive manufacturing techniques include material extrusion, jetting, selective laser sintering, powder/binder jetting, electron-beam melting, and stereolithographic processes. Examples of material extrusion AM techniques include fused filament fabrication (FFF), which is also referred to as fused deposition modeling (FDM), and pellet additive manufacturing (PAM), which includes big-area additive manufacturing (BAAM) and large-scale additive manufacturing (LSAM). For each of these techniques, the digital representation of the 3D part is initially sliced into multiple horizontal layers. For each sliced layer, a tool path is then generated, which provides instructions for the additive manufacturing system to print the given layer.

Some additive manufacturing processes can be costly, especially the laser-based processes involving the use of high-power lasers. More economical processes are extrusion-based processes such as FFF and PAM. In FFF, a filament, fiber, or strand enters the 3D printing device and a 3D object is formed by extruding the filament through a heated nozzle, where the filament is melted, to form layers, and where each layer hardens after extrusion, i.e., layer-by-layer deposition. Pellet additive manufacturing processes utilize polymer pellets and powders, fiber reinforcements, and other fillers and additives as the feedstock with the additive manufacturing system combining melting, compounding, and extrusion functions, enabling stiff, highly reinforced materials to be printed. It is advantageous for materials used in extrusion-based AM to be compatible with a broad nozzle/hot-end temperature range. For example, in some instances, increasing the nozzle temperature can improve interlayer adhesion and increase the mechanical performance of a 3D-printed part. In other instances, materials that are capable of being printed at lower nozzle temperatures, while still retaining functional and aesthetic properties, exhibit broad compatibility with a wide variety of printers. It is advantageous for materials used in fused filament fabrication to be capable of being wound onto a spool as a continuous strand with no breakages.

Moisture-tolerant materials are desirable for use in FFF, PAM and other extrusion-based 3D printing processes. 3D printers are used in a broad range of environments, often with high relative humidity. If the feedstock has absorbed moisture, printing at too high of a temperature will result in macroscopic bubbles, a rough surface, and compromised mechanical properties. Low water absorption is important for retaining the properties of the printed part, as water absorption alters dimensions as well as lowers mechanical properties such as stiffness and strength. In addition, parts printed by extrusion-based processes are often printed with soluble support structures, which are typically removed by immersing the printed part in an aqueous bath.

Polyamides, such as PA66 and PA6, are easy to process and have high melting points and high heat deflection temperatures, particularly when they have glass-fiber or carbon-fiber reinforcement or comprise mineral fillers. However, they typically have high water absorption and exhibit warpage or curl when printed due to rapid crystallization. Winding these highly crystalline polyamides as a continuous strand on a spool can be challenging, particularly when the composition incorporates glass or carbon reinforcement. Long-chain aliphatic polyamides, such as those composed of aminoundecanoic acid (PA11), laurolactam (PA12), or a combination of dodecanediamine and dodecanedioic acid (PA1212) have low water absorption and relatively low warpage when printed, but have low melting points, low modulus and low strength, even when dry. They are undesirable for technical applications at relatively high temperatures. Semicrystalline, semiaromatic polyamides have reduced water absorption and mechanical properties are substantially retained after water absorption. However, melting points are often too high to be processed by most desktop FFF printers.

High rates of crystallization of many semicrystalline polyamides adversely affect interlayer adhesion and induce shrinkage that may distort the article as it is printed. To address this issue, blends of semicrystalline and amorphous polyamides have been printed to slow the crystallization rate.

U.S. Patent application 2014/0141166 A1 discloses compositions for fused filament fabrication comprising substantially miscible blends of at least one semi-crystalline polyamide and at least one amorphous polyamide with preferred semicrystalline polyamides selected from non-aromatic polyamides including PA6, PA66, and PA12.

U.S. Pat. No. 5,391,640 discloses a blend of a conventional polyamide and an amorphous polyamide wherein such blends are relatively insensitive to humidity and exhibit good film barrier properties.

WO2017153586A1 discloses a semicrystalline copolyamide for FFF comprising at least 0.5 wt % of a cyclic monomer. A representative copolyamide of this application is PA-6/IPDT wherein IPD is isophoronediamine and T is terephthalic acid and wherein IPDT is present at 1 wt % in the copolyamide.

There is a need, therefore, for improved, readily tuned polymer compositions comprising semi-crystalline copolyamides for use in material extrusion additive manufacturing processes such as FFF and PAM that result in tailored features and mechanical properties of the resulting articles and/or an improved processing window. Such compositions should be processable over a broad temperature range and exhibit a combination of low curl/warpage, low moisture absorption, and good mechanical properties of both dry and conditioned parts.

### DETAILED DESCRIPTION OF THE INVENTION

### Description of the Drawings

The invention described and claimed herein will become better understood upon having reference to the drawings herein.

FIG. 1 is a view of a specimen including details of geometry and relevant to an ASTM tensile properties test, as more fully described herein;

FIG. 2 is a view of test bars in various directions including vertical, edge, or flat.

FIG. 3 is a view of articles having particular infill geometries as more fully described herein.

### ABBREVIATIONS

The claims and description herein are to be interpreted using the abbreviations and definitions set forth below.

“MI” refers to Melt Index.
“MPa” refers to megapascal.
“sec” refers to second
“psi” refers to pounds per square inch.
“%” refers to the term percent.
“wt. %” refers to weight percent.
“mm” refers to millimeters.
“mol. %” refers to mole percent.
“kN” refers to kilonewton
“IV” refers to inherent viscosity.
“RV” refers to relative viscosity.

### Definitions

As used herein, the article “a” refers to one as well as more than one and does not necessarily limit its referent noun to the grammatical category of singular number.

As used herein, the terms “about” and “at or about”, when used to modify an amount or value, refer to an approximation of an amount or value that is more or less than the precise amount or value recited in the claims or described herein. The precise value of the approximation is determined by what one of skill in the art would recognize as an appropriate approximation to the precise value. As used herein, the terms convey that similar values, not precisely recited in the claims or described herein, can bring about results or effects that are equivalent to those recited in the claims or described herein, for which one of skill in the art would acknowledge as acceptably brought about by the similar values.

As used herein, the term “article” refers to an unfinished or finished item, thing, or object, or an element or feature of an unfinished or finished item, thing or object. As used herein, when an article is unfinished, the term “article” may refer to any item, thing, object, element, device, etc. that has a form, shape, configuration that may undergo further processing in order to become a finished article. When an article is finished, the term “article” refers to an item, thing, object, element, device, etc. that is in a form, shape, configuration that is suitable for a particular use/purpose without further processing of the entire entity or a portion of it.

An article may comprise one or more element(s) or subassembly(ies) that either are partially finished and awaiting further processing or assembly with other elements/subassemblies that together will comprise a finished article. In addition, as used herein, the term “article” may refer to a system or configuration of articles.

As used herein, the term “additive manufacturing” (AM) refers to a process of joining materials together, usually in a layer-by-layer process, to form an article.

As used herein, the term “additive manufacturing system” refers to a set of connected parts forming a unit or units that prints, builds, or otherwise produces 3D items and/or support structures at least in part using additive manufacturing and may be a stand-alone unit, a sub-unit of a larger unit or production line, and/or may include other nonadditive manufacturing features, such as subtractive-manufacturing features, pick-and-place features, and two-dimensional printing features.

As used herein, the term “material extrusion” refers to a manufacturing process that is used to build a three-dimensional (3D) model from a digital representation of the 3D model in a layer-by-layer manner by selectively dispensing a flowable material through a nozzle or orifice. Typically, thermoplastic material is melted or heated to a flowable state and extruded as a series of layers, which cool down to form a 3D part. Feedstocks for material extrusion can include filaments, polymer pellets and powders, fiber reinforcements, and other fillers and additives. Material extrusion techniques include fused filament fabrication, pellet additive manufacturing, big-area additive manufacturing and large-scale additive manufacturing, as well as other material extrusion technologies as defined by ASTM F2792-12a.

As used herein, the terms “fused filament fabrication” (FFF) and “fused deposition modeling” (FDM) refer to an extrusion-based additive manufacturing process in which a three-dimensional article is produced by extruding a filament comprising a thermoplastic material through a heated nozzle to form layers, in which each layer is extruded on top of the previous layer, and which solidify after extrusion to form an article.

The term “relative strength”, as used herein, refers to a product of the tensile strength and elongation at break of test samples as determined by Equation 1:

Relative Strength=(Tensile Strength)×(% Elongation at Break/100) (1)

where the tensile strength and the percent elongation at break are each measured on test samples pursuant to ISO 527-2:2012. Accordingly, the relative strength of the test samples combines part strength and ductility measurements and is a good indicator for the robustness, fatigue life, etc. of printed 3D parts.

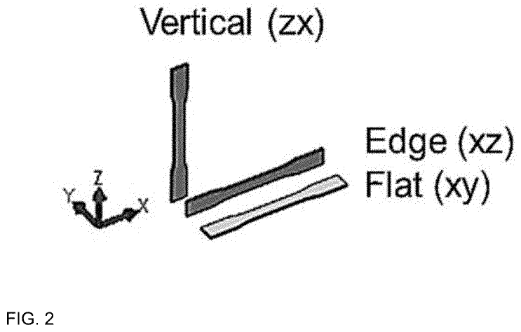

The term “ratio of vertical to flat tensile strength”, as used herein, refers to the tensile strength of a tensile bar printed in the vertical (zx) direction (see FIG. 2) divided by the tensile strength of a tensile bar printed in the flat (xy) direction, where the tensile strength is measured on test samples pursuant to ISO 527-2:2012 and the printing of both flat and vertical bars is conducted with the same printer, printing conditions and parameters. Accordingly, the ratio of vertical to flat tensile strength is an indicator for the strength of interlayer adhesion and the degree of anisotropy of properties of printed 3D parts.

As used herein, the term “curl” refers to the degree to which a 3D printed test sample bends at the end of the sample relative to a flat test sample in which the entire test sample is flat or straight with no bending. Curl is measured pursuant to the Curl Bar Test.

As used herein, the term “temperature range” refers to the range of nozzle or hot-end temperatures useful for 3D-printing parts with functional performance and desirable aesthetic surface appearance as observed by the unaided human eye. In other words, it is the temperature range in which no visible defects are observable on the surface of a printed test cylinder pursuant to the Temperature Range Test.

As used herein, the term “dry-as-printed” or “DAP” refers to test samples printed under a nitrogen environment, with the printed test samples kept under nitrogen until being sealed in aluminum bags under vacuum and stored until being tested.

As used herein, the term “conditioned” refers to articles/test samples printed under a nitrogen environment and conditioned at 23° C. and 50% RH for at least 40 h prior to testing.

As used herein, the term “ambient conditions” refers to an environment with a temperature in the range of about 20 to 25° C. and relative humidity in the range of about 35% to 60%.

As used herein, the term “aliphatic polyamide” refers to a polyamide that comprises greater than 95 mole percent aliphatic repeat units derived from one or more aliphatic dicarboxylic acids with 6 to 20 carbon atoms and one or more aliphatic diamines with 4 to 20 carbon atoms. Herein, the term “long-chain aliphatic polyamide” refers to an aliphatic polyamide with a repeating unit monomer length comprising greater than or equal to 10 carbon atoms.

As used herein, terms that describe molecules or polymers follow the terminology in the IUPAC Compendium of Chemical Terminology version 2.15 (International Union of Pure and Applied Chemistry) of Sep. 7, 2009.

### Ranges and Preferred Variants

Any range set forth herein expressly includes its endpoints unless explicitly stated otherwise. Setting forth an amount, concentration, or other value or parameter as a range specifically discloses all possible ranges formed from any possible upper range limit and any possible lower range limit, regardless of whether such pairs of upper and lower range limits are expressly disclosed herein. Polymer compositions, compounds, processes and articles described herein are not limited to specific values disclosed in defining a range in the description.

The disclosure herein of any variation in terms of materials, chemical entities, methods, steps, values, and/or ranges, etc.—whether identified as preferred or not—of the processes, polymer compositions, compounds, mixtures, and articles described herein specifically intends to include any possible combination of materials, methods, steps, values, ranges, etc.

In this description, if there are nomenclature errors or typographical errors regarding the chemical name of any chemical species described herein, the chemical structure takes precedence over the chemical name. And, if there are errors in the chemical structures of any chemical species described herein, the chemical structure of the chemical species that one of skill in the art understands the description to intend prevails.

### Generally

Disclosed herein are AM compositions which may be used in material extrusion additive manufacturing processes and may be in the form of filaments, pellets, and/or powders. Preferably, the desirable additive manufacturing processes in which these AM compositions may be used are fused filament fabrication, wherein said AM compositions are in the form of filaments, especially filaments which may be easily wound onto spools or reels, and pellet additive manufacturing, wherein said AM compositions are in the form of pellets of appropriate size which may be readily fed into the extruder of a PAM printer. The AM compositions are often compounded, preferably into well mixed or homogeneous mixtures, prior to preparing said filaments and pellets.

Additive Manufacturing compositions disclosed herein comprise:

A) 100 to 30 weight percent of at least one polyamide composition comprising:
a) 95 to 5 weight percent of at least one semi-crystalline copolyamide having a melting point, said semi-crystalline copolyamide comprising:
   i) 5 to 40 mole percent aromatic repeat units derived from one or more aromatic dicarboxylic acids with 8 to 20 carbon atoms and at least one aliphatic diamine with 4 to 20 carbon atoms; and
   ii) 60 to 95 mole percent aliphatic repeat units derived from one or more aliphatic dicarboxylic acids with 6 to 20 carbon atoms and one or more aliphatic diamines with 4 to 20 carbon atoms;
b) 5 to 95 weight percent of at least one amorphous copolyamide comprising:
   iii) 60 to 90 mole percent aromatic repeat units derived from isophthalic acid and at least one aliphatic diamine with 4 to 20 carbon atoms; and
   iv) 10 to 40 mole percent aromatic repeat units derived from terephthalic acid and at least one aliphatic diamine with 4 to 20 carbon atoms;
wherein the weight percent of (a) and (b) total 100 weight percent of polyamide composition (A); and

B) 0 to 70 weight percent of at least one additive; and

wherein the weight percent of (A) and (B) total 100 weight percent of the additive manufacturing composition.

Further disclosed herein are 3D printed articles comprising:

A) 99 to 30 weight percent of a polyamide composition comprising:
a) 85 to 65 weight percent of at least one semi-crystalline copolyamide having a melting point, said semi-crystalline copolyamide comprising:
   i) 5 to 40 mole percent aromatic repeat units derived from one or more aromatic dicarboxylic acids with 8 to 20 carbon atoms and at least one aliphatic diamine with 4 to 20 carbon atoms; and
   ii) 60 to 95 mole percent aliphatic repeat units derived from one or more aliphatic dicarboxylic acids with 6 to 20 carbon atoms and one or more aliphatic diamines with 4 to 20 carbon atoms;
b) 15 to 35 weight percent of at least one amorphous copolyamide comprising:
   iii) 60 to 90 mole percent aromatic repeat units derived from isophthalic acid and at least one aliphatic diamine with 4 to 20 carbon atoms; and
   iv) 10 to 40 mole percent aromatic repeat units derived from terephthalic acid and at least one aliphatic diamine with 4 to 20 carbon atoms;
wherein the weight percent of (a) and (b) total 100 weight percent of polyamide composition (A); and

B) 1 to 70 weight percent of at least one additive; and

wherein the weight percent of (A) and (B) total 100 weight percent of the 3D printed article.

Additionally disclosed herein are 3D printed articles comprising:

A) 100 to 30 weight percent of a polyamide composition comprising:
a) 95 to 5 weight percent of at least one semi-crystalline copolyamide having a melting point, said semi-crystalline copolyamide comprising:
   i) 5 to 40 mole percent aromatic repeat units derived from one or more aromatic dicarboxylic acids with 8 to 20 carbon atoms and at least one aliphatic diamine with 4 to 20 carbon atoms; and
   ii) 60 to 95 mole percent aliphatic repeat units derived from one or more aliphatic dicarboxylic acids with 6 to 20 carbon atoms and one or more aliphatic diamines with 4 to 20 carbon atoms;
b) 5 to 95 weight percent of at least one amorphous copolyamide comprising:
   iii) 60 to 90 mole percent aromatic repeat units derived from isophthalic acid and at least one aliphatic diamine with 4 to 20 carbon atoms; and
   iv) 10 to 40 mole percent aromatic repeat units derived from terephthalic acid and at least one aliphatic diamine with 4 to 20 carbon atoms;
wherein the weight percent of (a) and (b) total 100 weight percent of polyamide composition (A); and

B) 0 to 70 weight percent of at least one additive; and

wherein the weight percent of (A) and (B) total 100 weight percent of the 3D printed article.

Also disclosed herein are filaments and pellets prepared from said AM compositions and articles prepared using these filaments and/or pellets by material extrusion additive manufacturing processes, especially fused filament fabrication and pellet additive manufacturing processes.

Additionally disclosed herein are processes for producing filaments and pellets for use in material extrusion additive manufacturing processes.

### AM Compositions

AM compositions disclosed herein may be used in material extrusion additive manufacturing processes to prepare 3D printed articles. Especially disclosed herein are filaments for use in fused filament fabrication processes and pellets for use in pellet additive manufacturing, said filaments and pellets comprising a polyamide composition comprising a mixture of at least one semi-crystalline copolyamide, at least one amorphous copolyamide, and optionally at least one additional material. An advantage of the AM compositions disclosed herein is that the ratio of semi-crystalline copolyamide to amorphous copolyamide may be varied to alter the physical properties of 3D printed articles comprising these compositions. For example, if the concentration of amorphous copolyamide is greater than about 50 weight percent relative to semi-crystalline copolyamide, 3D printed articles comprising such AM compositions can be translucent or transparent and exhibit a combination of high strength, low warpage, and low moisture absorption.

3D printed articles prepared from AM compositions disclosed herein, especially when using fused filament fabrication and pellet additive manufacturing processes, exhibit lower warpage, less distortion, and desirable printability upon cooling compared to articles prepared using AM compositions which comprise only a semi-crystalline copolyamide or only an amorphous copolyamide.

### Semi-Crystalline Copolyamide (a)

Semi-crystalline copolyamide (a) used in polyamide composition (A) described herein is a copolyamide comprising 5 to 40 mole percent aromatic repeat units (i), preferably 10 to 30 mole percent (i), and 60 to 95 mole percent aliphatic repeat units (ii), preferably 70 to 90 mole percent (ii). Aromatic repeat units (i) comprise at least one aromatic dicarboxylic acid with 8 to 20 carbon atoms such as terephthalic acid, isophthalic acid, and 2,6-napthalenedioic acid. Terephthalic acid and isophthalic acid are preferred, with terephthalic acid most preferred.

Aliphatic repeat units (ii) comprise at least one aliphatic dicarboxylic acid with 6 to 20 carbon atoms and may include adipic acid, decanedioic acid, dodecanedioic acid, tridecanedioic acid, tetradecanedioic acid, hexadecanedioic acid, and octadecanedioic acid. Dodecanedioic acid, decanedioic acid, hexadecanedioic acid, and octadecanedioic acid are preferred aliphatic dicarboxylic acids, with dodecanedioic acid and decanedioic acid being most preferred.

Aromatic repeat units (i) and aliphatic repeat units (ii) may each comprise at least one aliphatic diamine having from 4 to 20 carbon atoms and may include hexamethylenediamine (HMD), 1,10-decanediamine, 1,12-dodecanediamine, and 2-methyl-1,5-pentamethylenediamine with hexamethylenediamine being preferred.

Non-limiting examples of semi-crystalline copolyamides (i) useful in the AM compositions include those selected from the group consisting of: poly(hexamethylene hexanamide/hexamethylene terephthalamide or PA 66/6T having a molar ratio of 66:6T ranging from (95/5) to (60/40), preferably (90/10) to (70/30), and more preferably (85/15) to (75/25); poly(hexamethylene dodecanamide/hexamethylene terephthalamide) or PA 612/6T having a molar ratio of 612:6T ranging from (95/5) to (60/40), preferably (90/10) to (70/30), and more preferably (85/15) to (75/25); poly(hexamethylene decanamide/hexamethylene terephthalamide) or PA 610/6T having a molar ratio of 610:6T ranging from (95/5) to (60/40), preferably (90/10) to (70/30), and more preferably (85/15) to (75/25); poly(hexamethylene hexadecanamide/hexamethylene terephthalamide) or PA 616/6T having a molar ratio of 616:6T ranging from (95/5) to (60/40), preferably (90/10) to (70/30), and more preferably (85/15) to (75/25); and poly(hexamethylene octadecanamide/hexamethylene terephthalamide) or PA 618/6T having a molar ratio of 618:6T ranging from (95/5) to (60/40), preferably (90/10) to (70/30), and more preferably (85/15) to (75/25).). Preferably, the semi-crystalline copolyamide is selected from the group consisting of PA 610/6T, PA 612/6T, PA 614/6T, PA 616/6T, and PA 618/6T.

### Amorphous Copolyamide (b)

Amorphous copolyamide (b) in polyamide composition (A) described herein is a copolyamide comprising 60 to 90 mole percent aromatic repeat units (iii), preferably 70 to 90 mole percent (iii), and 10 to 40 mole percent aromatic repeat units (iv), preferably 10 to 30 mole percent (iv).

Amorphous copolyamide (b) used in polyamide composition (A) described herein is a copolyamide having two or more amide and/or diamide molecular repeat units in which one repeat unit comprises terephthalic acid and the second repeat unit comprises isophthalic acid.

The diamines which may be used to prepare amorphous copolyamide (b) includes linear, branched, or cyclic aliphatic diamines with 4 to 20 carbon atoms. Examples of suitable diamines include hexamethylenediamine (HMD), 1,10-decanediamine, 1,12-dodecanediamine, 1,4-cyclohexanediamine, and 2-methyl-1,5-pentamethylenediamine with hexamethylenediamine being preferred.

Non-limiting examples of amorphous copolyamides useful in the AM compositions include those selected from the group consisting of: poly(hexamethylene isophthalamide/hexamethylene terephthalamide) or PA 6I/6T having a molar ratio of 6I:6T ranging from (60/40) to (95/5), preferably (70/30) to (80/20).

The weight ratio of semi-crystalline copolyamide (a) to amorphous copolyamide (b) in polyamide composition (A) ranges from about 95:5 to 5:95, preferably from 90:10 to 10:90, more preferably from 85:15 to 65:35 depending on the physical properties desired in the 3D printed articles.

Alternatively, and depending on the properties desired, the concentration of semi-crystalline copolyamide (a) in polyamide composition (A) may range from about 5 to 54 weight percent and the concentration of amorphous copolyamide (b) in polyamide composition (A) may range from about 46 to 95 weight percent wherein the total weight percent of semi-crystalline copolyamide (a) and amorphous copolyamide (b) in polyamide composition (A) equal 100 weight percent of polyamide composition (A).

Additive (B)

Compositions disclosed herein for use in additive manufacturing processes for preparing 3D printed articles may optionally comprise at least one additive (B) such as reinforcing agents, tougheners, fillers, adhesion promoters or compatibilizers, crystallization accelerators or crystallization retarders, flow aids, lubricants, mold-release agents, colorants, plasticizers, antioxidants, heat stabilizers, processing aids, flame retardants including halogen-free flame-retardants and synergists, antistatic agents, high-temperature copolyamides, aliphatic polyamides, and mixtures of any of these additives. Such additives, when present, provide 3D printed articles having improved properties relative to 3D printed articles which do not comprise at least one additive (B). Depending on the desired property, the concentration of additive (B) in the compositions, when present, may range from about 0.1 weight percent up to about 70 weight percent based on 100 weight percent of (A) and (B) in the composition.

Examples of reinforcing agents which may be used as additive (B) include fibrous and nonfibrous materials and mixtures of these. Examples of fibrous materials include circular and noncircular glass fibers, carbon fibers, silica carbide fibers, boron fibers, cellulose fibers, boron nitride fibers, ceramic fibers, and combinations of these. The reinforcing agent may include sizing or coupling agents, or organic or inorganic materials that improve the bonding between the reinforcing agent and copolyamides (a) and (b). Short fibers (e.g. chopped fibers whose length is from 1 to 20,000 micron) or continuous-filament fibers (rovings) can be used for reinforcement; short fibers are preferred.

Glass fibers which may be used as the reinforcing agent include sized and unsized glass fibers with a circular cross section and with a noncircular cross-section. Examples of sized glass fibers include E-glass, R-glass, S-glass, and S2-glass and can be obtained from companies such as Hexcel (Stamford, Conn.) and Nippon Electric Glass Co., Ltd (Schaumburg, Ill.). Additional sources of commercially available glass beads and chopped glass fiber include Potter Industries LLC (Valley Forge, Pa.), Nippon Glass Fiber Co. Ltd (Tsu, Japan), Chongqing Polycomp International (CPIC; Albany, N.Y.), and Dreytek, Inc. (Rockaway, N.J.).

Glass fibers with noncircular cross-section refer to glass fibers having a cross section in which the cross-section has a major axis lying perpendicular to a longitudinal direction of the glass fiber and corresponding to the longest linear distance in the cross section. The non-circular cross section has a minor axis corresponding to the longest linear distance in the cross section in a direction perpendicular to the major axis. The non-circular cross section of the fiber may have a variety of shapes including a cocoon-type (figure-eight) shape; a rectangular shape; an elliptical shape; a roughly triangular shape; a polygonal shape; and an oblong shape. As will be understood by those skilled in the art, the cross section may have other shapes. The ratio of the length of the major axis to that of the minor access is preferably between about 1.5:1 and about 6:1. The ratio is more preferably between about 2:1 and 5:1 and yet more preferably between about 3:1 to about 4:1. Suitable glass fibers are disclosed in EP 0 190 001 and EP 0 196 194.

Suitable dimensions for glass fibers include glass fibers with diameters of about 10 to 20 microns and continuous length or lengths of about 1 to 20,000 microns, 1 to 12,000 microns, 1 to 5000 microns, 1 to 3000 microns, 1 to 1000 microns, 1 to 400 microns, 1 to 300 microns, or 1 to 200 microns.

It is preferred that when noncircular glass fibers are used they have an aspect ratio (length:width ratio) of at least 3, more preferably at least 5, and most preferably at least 10.

The weight percent of glass fibers, when present in the composition, may range between 0.1 to 60 wt %, preferably 5 to 50 wt %, and more preferably 10 to 50 wt %, based on the total weight of polyamide composition (A) and additive (B) in the composition.

Carbon additives used as reinforcing agents include carbon black, carbon fiber (including graphite fiber), or mixtures of these. Carbon fibers can be any type, including, for example, those made from polyacrylonitrile (PAN), pitch, rayon, cellulose fibers, and recycled carbon fibers. Carbon fibers may be surface-treated with one or more sizing agents. Examples of suitable sizing agents include polyamides, urethanes, and epoxies. The presence of the sizing can help keep the fibers in the form of a bundle when bundles of long fibers are cut into chopped fibers having a length of several mm. Sizing may help improve dispersibility of the fibers in the compositions. If present, sizing may be about 1 to about 10 weight percent based on the total weight percent of sizing agent and carbon fibers. Carbon fibers may be treated with sizing agent using any suitable method known in the art. Suitable carbon fibers containing sizing agents can be purchased commercially.

Suitable dimensions for carbon fibers used herein include: diameter about 5 to 10 microns or about 6 to 8 microns and continuous length or length about 1 to 20,000 microns, 1 to 12,000 microns, 1 to 6000 microns, 1 to 3000 microns, 1 to 1000 microns, 1 to 400 microns, 1 to 300 microns; or 1 to 200 microns. Sources of chopped carbon fiber include DowAksa USA, LLC (Farmington Hills, Mich.), Mitsubishi Chemical Carbon Fiber and Composites (Sacramento, Calif.), Zoltek (Bridgeton, Mo.) and Toho Tenax America, Inc. (Rockwood, Tenn.). Sources of carbon black include Cabot Corporation (Billerica, Mass.) and Orion Engineered Carbons S.A. (Luxembourg).

The weight percent of carbon and/or carbon fibers when present as additive (B) may range from about 0.1 to 50 wt %, preferably 5 to 30 wt %, based on the total weight of polyamide composition (A) and additive (B) in the composition.

When present, any combination of reinforcing fibers may be used in the AM compositions including carbon fibers, glass fibers, and combinations of these.

Nonfibrous additives include materials such as solid glass beads, hollow glass beads, glass flake, glass microflake, ground glass, calcium carbonate, talc, mica, wollastonite, calcined clay, kaolin, diatomite, magnesium sulfate, magnesium silicate, barium sulfate, titanium dioxide, sodium aluminum carbonate, barium ferrite, potassium titanate, nanocellulose, silicate, quartz, amorphous silicates, magnesium carbonate, magnesium hydroxide, sodium aluminum carbonate, aluminum oxide, chalk, lime, feldspar, permanently magnetic or respectively magnetizable metal compounds and/or alloys, electrically conductive materials, thermally conductive materials, and mixtures thereof. Any combination of fibers and nonfibrous materials may be used as additive (B).

When used, solid glass bead diameters may range from about 1 to 2000 microns, 1 to 1000 microns, or about 1 to 400 microns. Hollow glass bead diameters may range from about 1 to 100 microns. Glass flake dimensions may range from about 5 microns thick and about 10 to 4000 microns wide to about 10 to 2000 microns wide. Glass microflake dimensions may range from about 2 to 5 microns thick and about 600 microns wide and include for example glass microflake having dimensions of about 5 microns thick to about 160 microns wide and about 2 microns thick to about 300 microns wide. It has surprisingly been shown that the presence of glass beads in 3D printed articles comprising the compositions disclosed herein can reduce anisotropy of 3D printed articles.

Examples of permanently magnetic or magnetizable metal compounds for use as additive (B) include common ferromagnetic metals such as iron, nickel, cobalt, gadolinium, dysprosium and steel alloys that contain specific ferromagnetic metals such as iron or nickel.

Examples of electrically conductive additives include carbon nanofibers, carbon black, graphite flakes, graphite powder, graphene nanoplatelets, carbon nanotubes, metallized mineral particles, and conductive micron or nano-sized metal particles including core-shell particles. Suitable conductive metals include silver, nickel, copper, aluminum, and mixtures thereof.

Examples of thermally conductive additives include aluminum oxide, boron nitride, aluminum nitride, silicon nitride, diamond, graphite, metal particles, carbon nanotubes and graphene.

Examples of tougheners for use as additive (B) include functionalized polymeric tougheners, nonfunctionalized polymeric tougheners, and mixtures thereof. A functionalized toughener has attached to it reactive functional groups which can react with the polyamide. Such functional groups are usually “attached” to the polymeric toughener by grafting small molecules onto an already existing polymer or by copolymerizing a monomer containing the desired functional group when the polymeric toughener molecules are made by copolymerization. As an example of grafting, maleic anhydride may be grafted onto a hydrocarbon rubber (such as an ethylene/α-olefin or ethylene/α-olefin/diene copolymer, an α-olefin being a straight chain olefin with a terminal double bond such as propylene, 1-butene or 1-octene) using free radical grafting techniques. The resulting grafted polymer has carboxylic anhydride and/or carboxyl groups attached to it. Commercial examples of functionalized polymeric tougheners include Fusabond®, Surlyn® and TRX® tougheners (E. I. DuPont de Nemours & Co. Inc., Wilmington, Del.) and Tafmer™ tougheners (Mitsui, Rye Brook, N.Y.).

Ethylene copolymers are an example of a polymeric toughening agent wherein the functional groups are copolymerized into the polymer, for instance, a copolymer of ethylene and a (meth)acrylate monomer containing the appropriate functional group. Herein the term ethylene copolymers include ethylene terpolymers and ethylene multi-polymers, i.e. having greater than three different repeat units. Herein the term (meth)acrylate means the compound may be either an acrylate, a methacrylate, or a mixture of the two. Useful functionalized comonomers for copolymerizing with ethylene include (meth)acrylic acid, carbon monoxide, sulfur dioxide, acrylonitrile, maleic anhydride, maleic acid diesters, (meth)acrylic acid, maleic acid, maleic acid monoesters, itaconic acid, fumaric acid, fumaric acid monoesters and potassium, sodium and zinc salts of said preceding acids, glycidyl (meth)acrylate, 2-hydroxyethyl (meth)acrylate, 2-isocyanatoethyl (meth)acrylate, glycidyl vinyl ether. In addition to ethylene and a functionalized comonomer, other monomers may be copolymerized into such a polymer, such as vinyl acetate and unfunctionalized (meth)acrylate esters such as ethyl (meth)acrylate, n-butyl (meth)acrylate, i-butyl (meth)acrylate and cyclohexyl (meth)acrylate.

Another functionalized toughener is a polymer having carboxylic acid metal salts. Such polymers may be made by grafting or by copolymerizing a carboxyl or carboxylic anhydride containing compound to attach it to the polymer. Useful materials of this sort include Surlyn® ionomers of ethylene copolymers (E. I. DuPont de Nemours & Co. Inc., Wilmington, Del.) comprising ethylene and a C₃ to C₈ α, β ethylenically unsaturated carboxylic acid wherein the carboxylic acid functionalities are at least partially neutralized with a metal, and the metal neutralized maleic anhydride grafted ethylene/α-olefin polymer described above. Metal cations for these carboxylate salts include Zn, Li, Na, Mg and Mn.

Ionomers for use as tougheners in the AM compositions disclosed herein can be prepared from ethylene and at least one C₃ to C₈ α, β ethylenically unsaturated carboxylic acid monomer. The carboxylic acid functionalities are partially neutralized by zinc ions, lithium ions, sodium ions, magnesium ions, and combinations of these ions to form ionomers. The ionomer may further comprise an additional metal in limited quantities so long as the properties of 3D printed articles prepared from such ionomers are not significantly decreased.

The C₃ to C₈ α, β ethylenically unsaturated carboxylic acid may be present from about 2 to about 30 weight percent, based on the total weight of ethylene and the at least one C₃ to C₈ α, β ethylenically unsaturated carboxylic acid monomer used to prepare the ionomer. Nonlimiting examples of suitable C₃ to C₈ α, β ethylenically unsaturated carboxylic acids include methacrylic acid, acrylic acid, and combinations thereof.

The carboxylic acid functionalities present in the ionomer are partially neutralized from about 10 to 99.5 percent with zinc, lithium, sodium or magnesium ions. Neutralization of the carboxylic acid functionality of the base resin may be accomplished by treating the base resin with inorganic base(s), as known in the art. Examples of such bases include zinc acetate, zinc oxide, lithium hydroxide, sodium methoxide, and magnesium acetate.

The ionomer may further comprise an additional comonomer selected from alkyl acrylate, alkyl methacrylate, or combinations of these. The comonomer may be present in a range from 0.1 wt % to about 40 wt % based on the total weight of all monomers used to prepare the ionomer. The alkyl groups of the alkyl acrylate and/or alkyl methacrylate may comprise from 1 to 8 carbon atoms with suitable alkyl groups chosen from among, for example, methyl, ethyl, propyl, and butyl such as n-butyl, sec-butyl, isobutyl and tert-butyl.

These ionomers may further comprise a reactive comonomer, such as maleic anhydride monoethylester, that can potentially react with the polyamide. The reactive comonomer may be present in a range from 0.1 wt % to about 10 wt %, preferably from about 0.5 wt % to about 7 wt %, based on the total weight of all monomers used to prepare the ionomer.

These ionomers may be characterized by a melt index ranging from about 0.5 g/10 minutes to 50 g/10 minutes using a 2.16 kg weight measured according to ASTM D1238-13.

It has also been discovered that some functionalized tougheners improve z-directional properties of these articles, as indicated by a ratio of vertical:flat tensile strength of greater than or equal to 0.5, 0.6 or 0.7. Preferred functionalized polymeric tougheners useful in improving the relative vertical tensile strength of 3D printed articles include those selected from the group consisting of ionomers of ethylene copolymers comprising ethylene and a C₃ to C₈ α, β ethylenically unsaturated carboxylic acid, wherein the carboxylic acid functionalities are at least partially neutralized with a metal, and ethylene/(meth)acrylate, ethylene/α-olefin or ethylene/α-olefin/diene copolymers grafted with an unsaturated carboxylic anhydride. Preferred ionomers of ethylene copolymers further comprise a reactive comonomer, an alkyl acrylate, an alkyl methacrylate or combinations of these, wherein the alkyl group comprises 1-8 carbon atoms. Preferred alkyl acrylates and alkyl methacrylates comprise 4 to 8 carbon atoms. Reactive comonomers are selected from the group consisting of maleic anhydride, maleic acid diesters, (meth)acrylic acid, maleic acid, maleic acid monoesters, itaconic acid, fumaric acid, fumaric acid monoesters, glycidyl (meth)acrylate, 2-hydroxyethyl (meth)acrylate, 2-isocyanatoethyl (meth)acrylate and glycidyl vinyl ether. Preferred reactive comonomers include maleic acid monoesters. A preferred metal for neutralization is zinc.

It is preferred that the functionalized polymeric toughener contain a minimum of about 0.5 and more preferably 1.0 weight percent of repeat units and/or grafted molecules containing functional groups or carboxylate salts (including the metal) and a maximum of about 16, more preferably about 13, and very preferably about 10 weight percent of monomers containing functional groups or carboxylate salts (including the metal). It is to be understood than any preferred minimum amount may be combined with any preferred maximum amount to form a preferred range. There may be more than one type of functional monomer present in the polymeric toughener, and/or more than one polymeric toughener present in the composition for extrusion additive manufacturing. For example, an ionomer and an ethylene/α-olefin copolymer grafted with an unsaturated carboxylic anhydride may be present. Often the toughness of the composition is increased by increasing the amount of functionalized toughener. However, increasing these amounts may also increase the melt viscosity, and the melt viscosity should preferably not be increased so much that 3D printing is made difficult.

Nonfunctionalized tougheners may also be present. Nonfunctionalized tougheners include polymers such as ethylene/α-olefin/diene (EPDM) rubber, polyolefins including polyethylene (PE) and polypropylene, and ethylene/α-olefin rubbers such as ethylene/1-octene copolymers available as ENGAGE® polymers from The Dow Chemical Company, Midland Mich. Other nonfunctional tougheners include styrene based polymers such as acrylonitrile-styrene copolymers, acrylonitrile-butadiene-styrene copolymers, acrylonitrile-styrene-acrylate copolymers, styrene-isoprene-styrene copolymers, styrene-hydrogenated isoprene-styrene copolymers, styrene-butadiene-styrene copolymers, and styrene-hydrogenated butadiene-styrene copolymers. For example, acrylonitrile-butadiene-styrene, or ABS, is a terpolymer made by polymerizing styrene and acrylonitrile in the presence of polybutadiene. The monomer proportions can vary from 15 to 35% acrylonitrile, 5 to 30% butadiene and 40 to 60% styrene.

The presence of tougheners in the AM compositions can improve the impact strength of 3D printed articles from about 1.4 to greater than 10 times the impact strength of an identical 3D printed article but which does not comprise a toughener.

Compositions disclosed herein may comprise up to 50 weight percent of one or more tougheners, preferably from 0.1 to 40, more preferably from about 2 to 30, and most preferably from 5 to 20 weight percent, based on the total weight of components A and B.

Examples of high temperature copolyamides which may be used as additive (B) in the AM compositions disclosed herein include, for example, poly(hexamethylene terephthalamide/hexamethylene dodecanamide) or PA 6T/612 having a molar ratio of 6T:612 ranging from (50/50) to (80/20), preferably (60/40) to (70/30); poly(hexamethylene terephthalamide/hexamethylene decanamide) or PA 6T/610 having a molar ratio of 6T:610 ranging from (50/50) to (80/20), preferably (60/40) to (70/30); poly(hexamethylene terephthalamide/hexamethylene hexadecanamide) or PA 6T/616 having a molar ratio of 6T:616 ranging from (55/45) to (80/20), preferably (60/40) to (70/30); poly(hexamethylene terephthalamide/hexamethylene octadecanamide) or PA 6T/618 having a molar ratio of 6T:618 ranging from (55/45) to (80/20), preferably (60/40) to (70/30); poly(hexamethylene adipamide/hexamethylene terephthalamide or PA 66/6T having a molar ratio of 66:6T ranging from (40:60 to (70:30); poly(hexamethylene terephthalamide/methylpentalene terephthalamide) or PA 6T/DT having a molar ratio ranging from (30:70) to (70:30); and poly(hexamethylene terephthalamide/hexamethylene isophthalamide/caprolactam or PA 6T/6I/6 having a molar ratio ranging from (55:30:15) to (75:20:5).

Additive (B) may also comprise one or more aliphatic polyamide(s). The weight percent of the one or more aliphatic polyamide(s), when present as additive (B), may range between 0.1 to 65 wt %, preferably 1 to 50 wt %, and more preferably 1 to 30 wt %, based on the total weight of polyamide composition (A) and additive (B) in the AM composition. Non-limiting examples of aliphatic polyamides useful as additive (B) include those selected from the group consisting of: poly(ε-caprolactam) (PA6), poly(hexamethylene hexanediamide/(ε-caprolactam) (PA66/6), poly(hexamethylene hexanediamide) (PA66), poly(hexamethylene decanediamide) (PA610), poly(hexamethylene dodecanediamide) (PA612), poly(decamethylene decanediamide) (PA1010), poly(11-aminoundecanamide) (PA11), and poly(12-aminododecanamide) (PA12). Preferred aliphatic polyamides include PA6, PA66/6, PA66, PA610, PA612, PA1010, PA11 and PA12. In some embodiments, additive (B) comprises one or more long-chain aliphatic polyamide(s). Preferred long-chain polyamides include PA610, PA612, PA1010, PA612, PA11, and PA12, with PA1010 most preferred.

More than one additive (B) may be present in the composition. When more than one additive (B) is present, the total concentration of all additives (B) does not exceed 70 weight percent based on the total weight of (A) and (B). Any combination of additives (B) disclosed herein may be used in the compositions for preparing 3D printed articles.

An example of the use of more than one additive (B) in the AM compositions includes mixtures of glass fibers and carbon fibers. When used in combination, the weight ratio of glass fibers to carbon fibers (glass fibers:carbon fibers) may range from 4:1 to 1:4. Such combinations improve the tensile properties of these AM compositions.

Additional examples of additive (B) combinations in which more than one additive (B) is present include various combinations of carbon fibers and/or glass fibers with tougheners, antioxidants, heat stabilizers, and colorants.

### Articles

It has surprisingly been found that when the compositions disclosed herein, in the form of filaments or pellets, are used to manufacture 3D printed articles using material extrusion additive manufacturing processes, the resulting 3D printed articles exhibit various combinations of low moisture absorption, low warpage, dimensional stability, a desirable balance of mechanical properties, as well as having broad processing windows to prepare these 3D printed articles. A further advantage of the compositions disclosed herein is they enable the production of filaments that can be spooled for use in FFF processes to prepare 3D printed articles. Surprisingly, filaments prepared from the compositions disclosed herein and comprising 50 weight % glass fiber as additive (B) can be spooled onto standard spools for desktop FFF printing without breaking. Due to brittleness, current commercial polyamide filaments for FFF are typically limited to a maximum of about 30 weight % glass fiber.

The specific combinations of semicrystalline and amorphous copolyamides disclosed herein exhibit broad compatibility with each other over a wide range of concentrations, enabling the optimization of the printing process and the tailoring of mechanical, chemical and visual properties of the resulting 3D printed articles. Compatibility of the semicrystalline and amorphous copolyamides is important to achieving 3D printed articles having desirable properties, such as reduced warpage, superior printing capability, high dimensional accuracy, and improved surface appearance compared to articles produced from AM compositions comprising either semi-crystalline copolyamides or amorphous copolyamides alone.

Articles 3D printed from the compositions disclosed herein exhibit mechanical properties which are similar for both dry and conditioned articles and exhibit desirable relative strengths and high heat deflection temperatures. Surprisingly, the visible surface quality of such 3D printed articles is good, even with reinforcing agents as high as 50 wt %. 3D printed articles comprising the compositions disclosed herein exhibit low moisture absorption, high modulus of elasticity, high tensile strength, high relative strength, and relatively high HDT, particularly when reinforced with glass and/or carbon fibers. Depending on the relative concentrations of semicrystalline and amorphous copolyamides in polyamide composition (A) and the nature of additives (B), the ratio of wet:dry tensile moduli of elasticity of 3D printed articles, as measured at room temperature, is greater than or equal to 0.85, preferably 0.90, more preferably 0.95, and most preferably 0.98 and the ratio of wet:dry maximum tensile strengths is greater than or equal to 0.85, preferably 0.90, more preferably 0.95, and most preferably 0.98.

Furthermore, when measured according to the Curl Bar Test, 3D printed articles comprising the compositions disclosed herein exhibit a height displacement of less than 2 mm, preferably less than 1 mm, and more preferably less than 0.5 mm. Compositions which exhibit low degrees of curl can be used to 3D print large, complex geometries with extrusion-based additive manufacturing systems such as FEF and PAM processes.

### Process for Preparing Compositions

AM compositions disclosed herein can be produced by feeding the at least one semi-crystalline copolyamide, the at least one amorphous copolyamide, and any optional additives into a device designed to mix molten thermoplastics, such as a single- or twin-screw extruder, Banbury® mixer, Farrel Continuous Mixer (FCM™), or a two-roll mill. The materials are fed into the mixing device where the thermoplastic polymers are heated to a molten state, mixed with any optional additives such as reinforcing agents and/or other additives, extruded or removed from the mixing device and cooled to form the AM compositions. The polyamide composition can be pelletized, granulated and/or extruded into filaments. Such processes are well known in the art.

### Processes for Producing Filaments and Pellets

Filaments, strands, or fibers for use in additive manufacturing processes, especially FFF processes, may be formed by any method known in the art. For example, filaments disclosed herein may be prepared by the following process steps:

1) pellets of the polyamide composition comprising semi-crystalline copolyamide, amorphous copolyamide, and any additional additives, are fed into an extruder in which the temperature of the extruder is sufficient to form a molten mixture; and

2) the molten mixture is extruded through a die and the extrudate is cooled to form a filament.

Alternatively, filaments disclosed herein may be prepared by the following process step: 1) Semi-crystalline copolyamide, amorphous copolyamide, and any additional additives are mixed at a temperature sufficient to form a molten mixture, the molten mixture is extruded through a die, and the extrudate is cooled to form a filament.

Process for Producing Articles

The AM compositions described herein may be used to prepare articles by additive manufacturing or 3-dimensional (3D) printing techniques, especially by fused filament fabrication processes, which preferably use filaments supplied from spools, and by pellet additive manufacturing processes, which preferably use pellets.

Fused filament fabrication is a process commonly used to prepare articles from filaments. Generally, in fused filament fabrication, a filament, comprising AM compositions disclosed herein, is fed through a heated die or nozzle wherein the temperature of the die is sufficiently high to melt the filament. The molten filament exits the die and is deposited in a layer-by-layer fashion to form the desired article. Control of deposition rate may be varied by altering the filament feed rate.

An example of a FFF process is as follows: A filament is unwound from a spool and fed to a heated nozzle, which can be turned on or off to control the flow and the temperature of the nozzle varied as needed. A worm-drive or pair of profiled wheels pushes the filament into the nozzle at a controlled rate. The nozzle heats the filament past its melting and/or glass transition temperature and the melted material/filament is deposited by a print head on a substrate to form a layer. Subsequent layers are deposited on top of the previous layer. After each layer is deposited, the position of the print head relative to the substrate is then incremented along a z-axis (perpendicular to the xy plane), and the process is then repeated to form a 3D part resembling the digital representation. The temperature of the melt is controlled such that the melted material solidifies substantially immediately (within several seconds) upon forming a layer on the base of the 3D printer, with the buildup of multiple layers to form the desired three-dimensional object.

Other extrusion-based AM processes, including “pellet additive manufacturing” (PAM) and “big area additive manufacturing” (BAAM), utilize polymer pellets and powders, fiber reinforcements, and other fillers and additives as the feedstock instead of filaments with the additive manufacturing system combining melting, compounding, and extrusion functions, enabling stiff, highly reinforced articles to be printed.

It is known in the art that the bed temperature, nozzle temperature, and other parameters used during preparation of 3D printed articles may affect the properties of the 3D printed article. Therefore, comparison of physical properties of 3D printed articles disclosed herein were performed using identical printing conditions for both examples and comparative examples, with the exception of the testing of some commercially purchased filaments, wherein the optimum of the manufacturers' recommended printing conditions were used.

More specifically, 3D printed articles disclosed herein may be prepared by the following process steps for FFF:
1) feeding a filament comprising the composition through a heated die at a temperature sufficient to form a melt mixture;
2) depositing the melt mixture in a layer-by-layer fashion to form the desired article.

More specifically, 3D printed articles disclosed herein may be prepared by the following process steps for PAM:
1) feeding pellets comprising the composition into the extruder of the printer and through a heated die at a temperature sufficient to form a melt mixture;
2) depositing the melt mixture in a layer-by-layer fashion to form the desired article.

### Examples

The exemplary compounds identified by “E” in the tables below are intended only to further illuminate and not to limit the scope of compounds, processes, and articles described and recited herein. Comparative examples are identified in the tables below by “C”.

### Materials

PA1 PA 612/6T (85/15) having an inherent viscosity of 1.25-1.40 dl/g; available from DuPont.
PA2 PA 6I/6T (70/30) having an inherent viscosity of 0.79-0.85 dl/g; available from DuPont.
PA3 PA 610/6T (80/20) having an inherent viscosity of 1.25-1.40 dl/g; available from DuPont.
PA4 Nylon 6 having an inherent viscosity of 1.42-1.58 dl/g; available from BASF (Florham Park, N.J.) as Ultramid B27 E 01.
PA5 PA 10/10 having an inherent viscosity of 0.80-0.90 dl/g; available from DuPont.
T1 Ionomer of an ethylene/methacrylic acid copolymer comprising ethylene and 15 wt % of methacrylic acid in which 22% of the carboxylic acid moieties are neutralized with zinc ions with MI of 14 g/10 min, measured according to ASTM D1238-13 using a 2.16 kg. weight; available from DuPont.
T2 Ionomer of ethylene/methacrylic acid copolymer comprising ethylene and 15 wt % of methacrylic acid in which 56% of the carboxylic acid moieties are neutralized with sodium ions with MI of 0.9 g/10 min, measured, according to ASTM D1238-13 using a 2.16 kg. weight; available from DuPont.
T3 Ionomer of ethylene/methacrylic acid/maleic anhydride monoethylester copolymer comprising ethylene, 11 wt % of methacrylic acid and 6 wt % of maleic anhydride monoethyl ester in which 40-60% of the carboxylic acid moieties are neutralized with zinc ions; available from DuPont.
T4 Ionomer of an ethylene/methacrylic acid copolymer comprising ethylene, 23.5 wt % n-butyl acrylate and 9 wt % of methacrylic acid in which 51% of the carboxylic acid moieties are neutralized with zinc ions with MI of 0.6 g/10 min, measured according to ASTM D1238-13 using a 2.16 kg. weight; available from DuPont.
T5 Ionomer of an ethylene/methacrylic acid copolymer comprising ethylene and 15 wt % of methacrylic acid in which 53% of the carboxylic acid moieties are neutralized with zinc ions with MI of 4.0 g/10 min, measured according to ASTM D1238-13 using a 2.16 kg. weight; available from DuPont.
T6 Ionomer of an ethylene/methacrylic acid copolymer comprising ethylene and 10.5 wt % of methacrylic acid in which 68% of the carboxylic acid moieties are neutralized with zinc ions with MI of 1.1 g/10 min, measured according to ASTM D1238-13 using a 2.16 kg. weight; available from DuPont.
T7 Ionomer of an ethylene/methacrylic acid copolymer comprising ethylene and 11 wt % of methacrylic acid in which 57% of the carboxylic acid moieties are neutralized with zinc ions with MI of 5.0 g/10 min, measured according to ASTM D1238-13 using a 2.16 kg. weight; available from DuPont.
B1 Commercially available blend of nylon 6 and an anhydride-containing ionomer of an ethylene copolymer sold as Surlyn Reflection Series® SURSG201UN by LTL Color Compounders, Inc. (Morrisville, Pa.). The ratio of nylon to ionomer is about 58 to 42 weight percent.
GF1 Chopped glass fiber having an average length of 3 mm; available as NEG T262H from Nippon Electric Glass Co., Ltd (NEG; Schaumburg, Ill.).
GF2 Solid glass beads with mean particle size of 11 micrometers and untapped bulk density of 60 lbs./cu. ft., measured according to ASTM D-1483; available as Spheriglass 5000 CP-3 from Potters Industries LLC (Valley Forge, Pa.).
CF1 Chopped carbon fiber having an average length of 6 mm; available as Zoltek™ PX35 Chopped Fiber (Type-45) from Toray Group (Bridgeton, Mo.).
CF2 Recycled aerospace grade chopped carbon fiber having an average length of 6 mm available from Toray Group (Bridgeton, Mo.).
AO1 Phenolic based antioxidant.
AO2 Antioxidant mixture.
AO3 UV stabilizer.
MB1 Masterbatch colorant which is 25 wt. % carbon black in nylon 6 carrier.
MB2 Masterbatch colorant which is 35 wt. % carbon black in EMA (Ethylene/Methacrylate) copolymer carrier.
HS1 Copper-based heat stabilizer.
HS2 Copper-based heat stabilizer.
HS3 Copper-based heat stabilizer.
AD1 Boron nitride having an average particle size of 30 micrometers; available as HS30 from Dandong Chemical Engineering Institute Co., Ltd. (DCEI; Dandong, China).
AD2 Synthetic graphite; available as TimRex KS 15 P1 from Imerys Graphite & Carbon (Westlake, Ohio).
PC Polycarbonate available from Stratasys Ltd.
F1 30 weight % glass-filled nylon6-based filament commercially available as Xstrand™ GF30-PA6 from Owens Corning in diameters of 2.85 and 1.75 mm.
F2 Glass-filled nylon12-based filament commercially available from EU Makers.
F3 Carbon-fiber-filled semi-aromatic polyamide based filament commercially available as CarbonX™ from 3DXTech.
F4 Carbon-fiber-filled nylon6-based filament commercially available as Carbonite® from Airwolf 3D.
F5 Carbon-fiber-filled nylon12-based filament commercially available from MatterHackers.
F6 Nylon6,6-based resin, heat stabilized and 50% glass fiber reinforced; available as Zytel® 70G50HSLA BK039B from DuPont.
T8 Ethylene/1-octene copolymer grafted with 1.8 wt % maleic anhydride; available from DuPont.
T9 Ethylene/1-octene copolymer with MI of 0.5 g/10 min, measured according to ASTM D1238 using a 2.16 kg. weight; available as Engage® 8180 from Dow Chemical Company (Midland, Mich.).
T10 Maleic anhydride-modified ethylene/1-butene copolymer; available as Tafmer® MH5040 from Mitsui Chemicals Inc. (Rye Brook, N.Y.)
T11 Maleic anhydride functionalized ethylene butyl acrylate copolymer having a melt index (190° C., 2.16 kg) of 5.6 g/10 min; available as Fusabond® A560 from DuPont.
T12 Maleic anhydride-modified ethylene/1-octene copolymer; available as Fusabond® N493 from DuPont.
T13 Maleic anhydride-modified co-grafted polypropylene and ethylene/1-octene copolymer as disclosed in US 2016/0264777 A1.

### Test Methods

Tensile strength, tensile modulus, and strain at break were measured following ISO 527-2:2012. In the Examples, all 3D-printed tensile bars were ISO 5A bars, unless otherwise noted. Tensile properties were measured at an initial test speed of 1 mm/min, then unfilled bars were measured at a secondary test speed of 50 mm/min and filled bars were measured at a secondary test speed of 5 mm/min. All injection-molded tensile bars were ISO 1A bars with the unfilled bars measured at a secondary test speed of 50 mm/min and the filled bars measured at a secondary test speed of 5 mm/min. All 3D-printed test bars were printed under a nitrogen purge. “Conditioned” bars, both 3D-printed and injection-molded, were conditioned at 23° C. at 50% RH for at least 40 h before being tested. Dry-as-printed (DAP) bars were stored under nitrogen prior to being sealed in aluminum bags under vacuum. The injection-molded bars tested as “dry-as-molded (DAM)” were sealed in aluminum bags under vacuum within 20-30 min after being molded to maintain moisture levels below 0.2%. For both DAP and DAM bars, the bags were opened immediately before testing, and the bars were tested without any conditioning.

Relative strength was calculated according to Equation 1, wherein the tensile strength and percent elongation at break are each measured pursuant to ISO 527-2:2012.

Heat deflection temperature (HDT) values were determined according to ISO 75-2:2013 method B, using a flexural stress of either 66 psi (0.45 MPa) or 261 psi (1.8 MPa), as specified in the Examples. Bars with dimensions of 80 mm×10 mm×4 mm were either 3D-printed or prepared from injection-molded ISO 1A MPB. All bars were tested either “dry-as-printed” or “dry-as-molded” unless specified otherwise.

Impact strength and impact energy were determined according to ISO 180:2000 methods A (ISO 180/A, notched Izod) or U (ISO 180/U, unnotched Izod). Bars with dimensions of 80 mm×10 mm×4 mm were either 3D-printed or prepared from injection-molded ISO 1A MPB. All bars were prepared “dry-as-printed” or “dry-as-molded”, as specified in the Examples, and measured without conditioning unless specified otherwise.

Curl Bar Test: This test was adapted from US20140141166 A1 and is used to measure the amount of curl in a 3D-printed test sample. Printing of the test samples is performed in a layer-by-layer manner using an extrusion-based additive manufacturing system as specified. For FFF, the test involves treating the entire bed of the 3D printer with a sheet of polyether imide (PEI), commercially available from Aleph Objects, Inc. (Loveland, Colo.; Lulzbot® TAZ PEI sheet; part number 817752016438), and then printing a test bar from tool path instructions to ideally have a 270 mm length, a 10 mm width, and a 10 mm vertical height using the following printer settings: 0.35 to 0.5 mm nozzle, 0.20 mm layer height, 100% 45/−45 degree infill, 1 shell, and 100% flow. The nozzle and bed temperatures, printing speed, and cooling can be adjusted according to the material being printed. Herein for compositions of the present invention, a nozzle temperature of 275° C., a bed temperature of 85° C. and a printing speed of 30 mm/sec were used, unless specified otherwise, with no cooling fan. A light layer of glue stick (Elmer's Washable Glue Stick) was applied prior to printing. After the test bar was printed, it was removed from the system and measured for curl at room temperature (25° C.). The curl of the material manifests itself by the ends of the test bar curling up, such that the test bar will bow or curl. The curl measurement involves identifying a line that connects the ends of the test bar in the longest dimension and locating the midpoint along the length of the test bar between the ends. The amount of curl is then measured as the height of the displacement of the ends of the test bar measured from the line between the two ends of the test bar to the surface of the test bar at the midpoint. This height of the displacement may be measured with a micrometer and recorded in mm. In other words, a line is drawn between the edge of the two ends in the lengthwise direction (longest direction) of the test bar. The distance or height between the midpoint of the test bar in the lengthwise direction and the line created by the two ends of the test bar is the degree of curl in mm.

Temperature Range Test: This test involves printing a single-wall cylinder with 0% infill and 0.2 mm layer height at various nozzle temperatures. A range of nozzle temperatures can be explored by varying the temperature with height. Software from Cura or Simplify3D may be used to run these tests; the use of this software for this test is easily within the capabilities of one skilled in the art. The single-wall cylinder has a diameter of 40 mm and total vertical height of 120 mm, although the height may be varied to, for example, test a wider temperature range or accommodate finer step-changes in temperature. Temperature ranges are as specified, e.g., from 290° C. to 235° C. with the temperature starting at the highest test temperature and decreasing by 5° C. for every 10-mm increase in height. A print speed of 30 mm/sec was used with no cooling fan, unless specified otherwise. Once the cylinder has been printed, the cylinder is inspected using the unaided human eye for defects. Common defects include bubbles due to release of moisture, cracks in the cylinder wall, roughness, waviness, and unraveling of the printed strand due to poor interlayer adhesion, particularly at lower temperatures. The temperature region in which the material for extrusion additive manufacturing can be printed into a 3D cylinder test sample without visible bubbles, cracks, delamination or other defects is recorded as the printing temperature range. Any temperature region in which a defect is observed is excluded from the temperature range, with the temperature range defined as the largest continuous region for which defects are not observed, as calculated in Equation 3, with T1 the highest temperature included in this region and T2 the lowest temperature included in this region, with temperatures measured in degrees Celsius. If the cylinder prints with defect-free walls at the highest attempted temperature, T1 is assigned as that temperature. If the cylinder prints with defect-free walls at the lowest attempted temperature, T2 is defined as that temperature.

Temperature Range=T1−T2 (3)

Procedure for Making Pellets and Molded Articles

Compositions in comparative examples C12 to C18 and examples E1-E80 were produced by a melt blending process. Compositions disclosed in Tables 1 through 5 were produced by co-feeding the raw materials into a Coperion 26 mm twin screw extruder. Barrel temperatures were set between 220-280° C. to ensure melting and adequate mixing. The melt mixture was extruded through a die, quenched in a water bath at a temperature between 5-60° C., cut into pellets, and dried in a vacuum oven at 80° C. under a sweep of nitrogen overnight. The dried pellets were then packaged or molded into articles.

The dried pellets were then fed into an Arburg 1.5 oz injection molding machine. Barrel temperatures were set between 220-280° C. to achieve an optimal melt, which was then molded into ISO 1A bars by injecting the melt into a mold cavity maintained between 25-80° C. Molded bars were ejected from the cavity, then sealed in aluminum bags under vacuum for storage in dry-as-molded condition until testing.

### Pellet Extrusion Molding Process

Dried pellets were loaded into the hopper of a Large-Scale Additive Manufacturing (LSAM®) machine (Thermwood; Dale, Ind.). The build surface was coated with pellets to prime adhesion of the extruded bead to the surface. Barrel temperatures were set to 270-310° C., with temperature progressively increasing from the first barrel to the nozzle, which was set to 320° C. Sixty layers were printed to produce a large (20″ in diameter, 12″ tall, 0.75″ wall thickness) hexagon, with a three minute per layer print time.

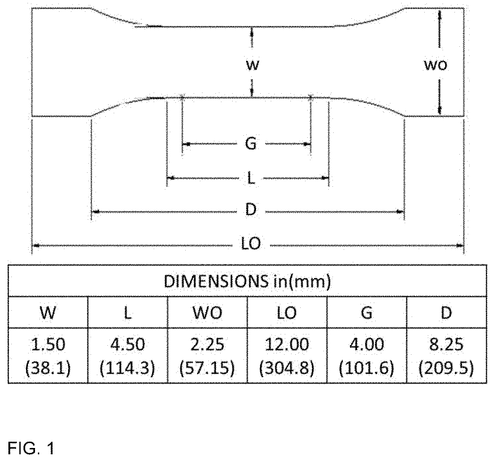

Specimens were prepared from the walls of the hexagon by machining and water jet cutting to fabricate test coupons. Each specimen was inspected to ensure that the test coupon was free of visible flaws, scratches or imperfections. Tensile tests were conducted in a temperature- and humidity-controlled environment with average conditions of 22° C./50% RH. Determination of tensile properties followed the guidelines proposed by ASTM D638:2014, Standard Test Method for Tensile Properties of Plastics, with the substitution of a non-standard specimen geometry, as shown in FIG. 1. A 5000 kN capacity, servo-hydraulic, load frame, manufactured by Instron (Norwood, Mass.) was used to provide a constant rate of extension of 0.2 in/min (˜5 mm/min) for tensile characterization. Hydraulic grips with a maximum capacity of 250 kN were used with matched sets of serrated grip faces to prevent material slipping or initiation of grip failures. The grips and load string were aligned before testing. Displacement was measured using a laser extensometer (Model LE-05, Electronic Instrument Research Ltd.; Irwin, Pa.) over a nominal starting gage length of 2.0 in (50.8 mm). Transverse displacement, needed for Poisson's Ratio determination, was measured with commercially available image correlation software and hardware (gom.com).

Specimen geometry for FIG. 1 is as follows, (dimensions in (mm)):
W 1.50 (38.1)
L 4.50 (114.3)
WO 2.25 (57.15)
LO 12.00 (304.8)
G 4.00 (101.6)
D 8.25 (209.5)

### Procedure for Making Filaments

Filaments used for comparative examples C4-C10 were purchased from filament suppliers. Filaments used for comparative examples C12, C14-C18, and examples E1-E80 were produced by a two-step process where the raw materials were first compounded, and filaments were subsequently produced using the compounded pellets produced in the first step as starting materials. Compounding was carried out by co-feeding the raw materials into a Coperion 26 mm twin screw extruder. Barrel temperatures were set between 220-280° C. to ensure melting and adequate mixing. The melt mixture was extruded through a die, quenched in a water bath at a temperature between 5-60° C., cut into pellets, and dried in a vacuum oven at 80° C. under a sweep of nitrogen overnight. The dried pellets were sealed in aluminum bags under vacuum before being used to produce filaments. The dried pellets were then fed into a 1.25 inch (32 mm) Brabender single-screw extruder. Barrel temperatures were set between 220-280° C. to achieve optimal filament quality depending on the specific polymer composition being processed. The melt mixture coming out of the die was quenched in a water bath at a temperature between 5-60° C. to form a filament. The resulting filament was wound onto spools using a strand puller at a rate to prevent breakage. Two diameters of filaments, 2.85 mm and 1.75 mm, were produced by adjusting the pulling rate. Comparative examples C1, C2, and C11 were produced by a similar process using a 1.25 inch (32 mm) Brabender single-screw extruder with barrel temperature between 220-280° C., a water quenching bath with a temperature between 5-60° C. to form filaments, followed by a winding process to produce filaments of both 2.85 mm and 1.75 mm diameters. These filaments were used to print 3D articles of the Examples.

### Fused Filament Fabrication Process

The following printers were used, as specified, for the examples described herein: (a) Lulzbot® Mini and Lulzbot® TAZ6 (Aleph Objects, Inc. Loveland, Colo.), each equipped with a hexagon hot-end and 0.5 mm hexagon style nozzle and utilizing nominally 2.85 mm filament. (b) Lulzbot® Mini and Lulzbot® TAZ6 (Aleph Objects, Inc. Loveland, Colo.), each equipped with an aerostruder hot-end and 0.5 mm E3D nozzle and utilizing nominally 2.85 mm filament. (c) Makergear M2 and Makergear M3 (Makergear, LLC; Beachwood, Ohio), equipped with a direct-drive hot-end and 0.35 mm, 0.4 mm or 0.5 mm nozzles and utilizing nominally 1.75 mm filament. Unless specified otherwise, properties across all examples and comparative examples within the same table are compared using the same printer/hot end/nozzle combination. Hardened-steel or abrasion-resistant nozzles were used when printing any composition comprising fillers.

Standard printing conditions for nylon test bars were 30 mm/sec with 0.2 mm layer height and no cooling fan, unless noted otherwise. Test bars can be tested in various directions including vertical, edge, or flat as shown in FIG. 2 and are listed in the tables as bar type.

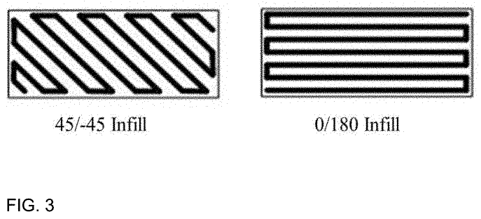

FIG. 3 exemplifies the two infill geometries described herein. After a layer outline is printed, the article infill can be printed at a 45 degree angle, zigzagging across the article, to provide a 45/−45 degree infill or back and forth, lengthwise, across the part to provide a 0/180 degree infill. Unless noted otherwise, all parts were printed with 45/−45 degree infill.

Table 1 shows the properties of various 3D-printed test samples prepared from AM compositions comprising blends of semicrystalline polyamides with greater than 45 wt % amorphous polyamides as disclosed herein. All the test bars for the examples and comparative examples in table 1 were printed on a Lulzbot Mini equipped with a hexagon extruder and 0.5 mm nozzle or Makergear M2 equipped with a 0.35 mm nozzle under a nitrogen-purged atmosphere at 30 mm/sec at a nozzle temperature of 275° C. and a bed temperature of 85° C. with no cooling fan. Tensile properties were measured for DAP bars. Curl was measured according to the Curl Bar Test with the bars printed on a Makergear M2 equipped with a 0.35 mm nozzle. For the temperature range test, print temperatures ranged from 295-220° C., stepping down the temperature by 5° C. in 10 mm increments while printing a hollow cylinder according to the Temperature Range Test. Printing speed was 30 mm/sec with no fan and a Lulzbot TAZ6 or Lulzbot Mini equipped with a hexagon extruder and 0.5 mm nozzle was used as the printer. Appearance was designated as opaque, translucent, or transparent. Opaque is defined as blocking the passage of light such that objects, when attempted to be viewed through the printed article, are not visible. Translucent is defined as semitransparent, e.g., allowing light to pass through it, but diffusing the passage of light such that objects viewed through the printed article are not clearly visible. Transparent is defined as allowing light to pass through such that objects viewed through the printed article are clearly visible.

Comparative Examples C1 and C2 are semi-crystalline polyamides PA1 and PA3 which do not comprise amorphous copolyamide PA2. Examples E1 to E4 are blends of either PA1 or PA3 with amorphous copolyamide PA2 from 50 wt. % to 90 wt. %. Comparative Example C3 is a polycarbonate 3D printing filament. Incorporation of amorphous materials in Examples E2 to E4 improves tensile strength (over 28% up to 60%) while maintaining high modulus (>1800 MPa) compared with C1 to C2 which do not comprise PA2. The higher levels of amorphous copolyamide in E2 to E4 also provide higher modulus and relative strength as compared to C14 (Table 10) and C18 (Table 11), which comprise just 20 wt % of amorphous copolyamide PA2 and 80 wt % of semicrystalline copolyamide PA1 and produce opaque 3D printed articles. Examples E1 to E4 have strain at break values greater than polycarbonate (C3), a high-performance engineering plastic. Examples E1 to E4 exhibit a broad printing window (greater than 50° C.). The curl bar test indicates low warpage (below 2 mm in E1 and below 0.5 mm in E2 to E4) compared to C1 and C2, which show over 10 mm curl. Articles printed from Examples E2 to E4 have a translucent to transparent appearance, which can be desirable both aesthetically and functionally in 3D-printed parts. The blend of semi-crystalline copolyamide with greater than 45 wt % amorphous copolyamide provides a combination of improved mechanical properties and printing benefits and imparts desirable attributes in 3D-printed articles, such as low warpage and tunable optical clarity.

TABLE 1

| | C1 | C2 | C3 | E1 | E2 | E3 | E4 |
|---|---|---|---|---|---|---|---|
| PA1 | 100 | — | | 50 | 20 | — | 10 |
| PA2 | — | — | | 50 | 80 | 70 | 90 |
| PA3 | — | 100 | | — | — | 30 | — |
| PC^{a} | | | 100 | | | | |
| Bar Type^{b} | flat | flat | edge | flat | flat | flat | flat |

Physical Properties

| | | | | | | | |
|---|---|---|---|---|---|---|---|
| Tensile | 1801 | 1727 | 1944 | 1396 | 2022 | 1838 | 1855 |
| Modulus | | | | | | | |
| (MPa) | | | | | | | |
| Tensile | 51 | 60 | 57 | 47 | 82 | 79 | 77 |
| Stress | | | | | | | |
| (MPa) | | | | | | | |
| Strain at | 12 | 11 | 4.8 | 4.9 | 6.3 | 6.2 | 6.5 |
| Break (%) | | | | | | | |
| Relative | 6.3 | 6.5 | 2.7 | 2.3 | 5.1 | 4.9 | 5.0 |
| Strength | | | | | | | |
| (MPa) | | | | | | | |
| Curl^{c} | >10 | >10 | | 2 | <0.5 | <0.5 | <0.5 |
| (mm) | | | | | | | |
| T Range^{d} | | | | 70 | 55 | 55 | 50 |
| (° C.) | | | | (295-225) | (295-240) | (295-240) | (295-245) |
| Appearance | opaque | opaque | | opaque | trans- | trans- | trans- |
| | | | | | lucent | lucent | parent |

^{a}Physical properties were obtained from supplier technical data sheet.
^{b}Bar type used only for tensile and relative strength testing.
^{c}Values obtained using curl bar test.
^{d}Values obtained using temperature range test; maximum to minimum temperature of the range in parentheses; T range is temperature range.

Tables 2 and 3 show the properties of various 3D printed test samples prepared from AM compositions disclosed herein and which comprise various reinforcing agents. All the test bars for the examples and comparative examples in tables 2 and 3 were printed under a nitrogen-purged atmosphere on a Lulzbot Mini equipped with a hexagon extruder and 0.5 mm nozzle using 2.85 mm filament except for comparative example C6, which was printed on a Makergear M2 equipped with a 0.35 mm nozzle using 1.75 mm filament. Tensile properties are reported for DAP bars, except for E13, which was conditioned.

Examples E5-E14 are 30% glass-fiber-filled AM compositions optionally with additives, such as carbon black colorants, antioxidants, and heat stabilizers. Compared with C4 and C5, which comprise a commercial 30% GF PA6 composition, the Examples show comparable or higher tensile strength and tensile modulus. The Examples also show higher strain at break and impact strength. These results correlate with the observation of the brittleness of C4 and C5 which exhibit brittle failure upon bending. In contrast, filaments in examples E5-E14 show ductile failure upon bending, which provides both printing and process advantages. A spool of as-purchased C4 (2.85 mm) filament had a break in the middle of the spool of filament, which resulted in a failed print. Also, a spool of as-purchased C4 (1.75 mm) filament had two breaks in the filament upon unboxing and examining the spool.

Compared to C6, which is a nylon 12 based filament, examples E5-E14 clearly show significantly higher tensile strength, tensile modulus, and impact strength of 3D printed articles. Example E13 shows no significant change in mechanical properties for conditioned test samples compared to dry or unconditioned samples. Example E14 showed comparable mechanical properties when the printing bed was set at 23° C. compared to examples where the printing bed was at 85° C. For Examples E13 and E12, the ratio of wet:dry tensile moduli is 1.13 and the ratio of wet:dry tensile strengths is 1.23.

The results in table 3 show the physical properties of various carbon fiber filled AM compositions. All examples and comparative examples in table 3 were printed at a nozzle temperature of 275° C. and a bed temperature of 85° C.

Examples E15-E22 exhibited an improved combination of both high modulus, high tensile strength and high impact strength compared to commercial carbon-filled filaments C7-C10. HDT for E18 and E20 were at least 56 percent greater than the HDT of a commercial semi-crystalline polyamide (C8).

TABLE 2

| | C4 | C5 | C6 | E5 | E6 | E7 | E8 | E9 | E10 | E11 | E12 | E13 | E14 |
|---|---|---|---|---|---|---|---|---|---|---|---|---|---|
| PA1 | | | | 53.6 | 54.4 | 53.4 | | 53.0 | | 52.8 | | | |
| PA2 | | | | 13.4 | 13.6 | 13.3 | | 13.2 | | 13.2 | | | |
| GF1 | | | | 30 | 30 | 30 | | 30 | | 30 | | | |
| AO1 | | | | | | | | 0.5 | | | | | |
| AO2 | | | | | | | | | | 0.7 | | | |
| MB1 | | | | 3 | | 3 | | 3 | | 3 | | | |
| MB2 | | | | | 2 | | | | | | | | |
| HS1 | | | | | | 0.3 | | 0.3 | | 0.3 | | | |
| F1 | 100 | | | | | | | | | | | | |
| F2 | | | 100 | | | | | | | | | | |
| Bar Type^{a} | flat | edge | flat | flat | flat | flat | edge | flat | edge | flat | edge | flat | flat |
| Nozzle | 280 | 280 | 240 | 275 | 275 | 275 | 275 | 275 | 275 | 275 | 275 | 275 | 275 |
| Temp^{a} | | | | | | | | | | | | | |
| (° C.) | | | | | | | | | | | | | |
| Bed | 100 | 100 | 25 | 85 | 85 | 85 | 85 | 85 | 85 | 85 | 85 | 85 | 23 |
| Temp^{a} | | | | | | | | | | | | | |
| (° C.) | | | | | | | | | | | | | |

Physical Properties

| Tensile | 4209 | 4158 | 1470 | 4126 | 4088 | 4429 | 4964 | 3939 | 4613 | 3812 | 4504 | 4299 | 4052 |
|---|---|---|---|---|---|---|---|---|---|---|---|---|---|
| Modulus | | | | | | | | | | | | | |
| (MPa) | | | | | | | | | | | | | |
| Tensile | 99 | 84 | 40 | 98 | 96 | 111 | 111 | 91 | 101 | 88 | 95 | 108 | 98 |
| Stress | | | | | | | | | | | | | |
| (MPa) | | | | | | | | | | | | | |
| Strain at | 3.1 | 2.6 | 5.5 | 3.7 | 3.9 | 4.1 | 3.4 | 3.4 | 3.3 | 3.5 | 2.9 | 4.7 | 3.9 |
| Break (%) | | | | | | | | | | | | | |
| Relative | 3.1 | 2.2 | 2.2 | 3.7 | 3.8 | 4.5 | 3.8 | 3.1 | 3.3 | 3.1 | 2.8 | 5.0 | 3.9 |
| Strength | | | | | | | | | | | | | |
| (MPa) | | | | | | | | | | | | | |
| Impact | 10 | 18 | 10 | 20 | 11 | | 19 | | 20 | | 21 | | |
| Strength^{b} | | | | | | | | | | | | | |
| (kJ/m²) | | | | | | | | | | | | | |
| HDT^{c} | | 176 | | | | | 171 | | 169 | | 158 | | |
| (° C.) at | | | | | | | | | | | | | |
| 0.45 MPa | | | | | | | | | | | | | |
| HDT^{c} | | 131 | | | | | 109 | | 106 | | | | |
| (° C.) at | | | | | | | | | | | | | |
| 1.8 MPa | | | | | | | | | | | | | |
| T Range^{d} | 75 | | 55 | | | | | | | 75 | | | |
| (° C.) | (295-220) | | (295-240) | | | | | | | (295-220) | | | |
| (max-min) | | | | | | | | | | | | | |
| Curl^{e} | <0.5 | | 7 | | | | | | | <0.5 | | | |
| (mm) | | | | | | | | | | | | | |
| z | z | z | z | z | z | z | z | z | z | z | z | z | z |

^{a}Bar type, nozzle, and bed temperatures used only for tensile and relative strength testing.
^{b}Values determined according to ISO 180: 2000 method A (ISO 180/A, notched Izod).
^{c}Values determined according to ISO 75-2: 2013 method B.
^{d}Values obtained using temperature range test; maximum to minimum temperature of the range in parentheses; T range is temperature range.
^{e}Values obtained using curl bar test.

TABLE 3

| | Example | | | | | | | | | | | |
|---|---|---|---|---|---|---|---|---|---|---|---|---|
| | C7 | C8 | C9 | C10 | E15 | E16 | E17 | E18 | E19 | E20 | E21 | E22 |
| PA1 | | | | | 64 | | 68 | | 60 | | 56 | |
| PA2 | | | | | 16 | | 17 | | 15 | | 14 | |
| CF1 | | | | | 20 | | | | | | | |
| CF2 | | | | | | | 15 | | 25 | | 30 | |
| F3 | 100 | | | | | | | | | | | |
| F4 | | | 100 | | | | | | | | | |
| F5 | | | | 100 | | | | | | | | |
| Bar type^{a} | Flat | Edge | Flat | Flat | Flat | Edge | Flat | Edge | Flat | Edge | Flat | Edge |

Physical Properties

| | | | | | | | | | | | | |
|---|---|---|---|---|---|---|---|---|---|---|---|---|
| Tensile | 4063 | 4557 | 2106 | 2128 | 4492 | 5713 | 3761 | 4871 | 5096 | 7155 | 6462 | 8354 |
| Modulus | | | | | | | | | | | | |
| (MPa) | | | | | | | | | | | | |
| Tensile | 65 | 62 | 49 | 49 | 98 | 102 | 84 | 88 | 124 | 117 | 125 | 130 |
| Stress | | | | | | | | | | | | |
| (MPa) | | | | | | | | | | | | |
| Strain at | 3.9 | 2.9 | 6.5 | 5.8 | 3.4 | 2.9 | 3.5 | 2.8 | 3.2 | 2.5 | 3.3 | 2.3 |
| Break (%) | | | | | | | | | | | | |
| Relative | 2.5 | 1.8 | 3.2 | 2.8 | 3.3 | 2.9 | 2.9 | 2.5 | 4.0 | 3.0 | 4.2 | 2.9 |
| Strength | | | | | | | | | | | | |
| (MPa) | | | | | | | | | | | | |
| Impact | 8 | 7 | 8 | 7 | 10 | 20 | | 13 | | | | |
| Strength^{b} | | | | | | | | | | | | |
| (kJ/m²) | | | | | | | | | | | | |
| HDT^{c} | | 105 | | | | 160 | | 164 | | 168 | | |
| (° C.) at | | | | | | | | | | | | |
| 0.45 MPa | | | | | | | | | | | | |
| HDT^{c} | | | | | | 105 | | | | | | |
| (° C.) at | | | | | | | | | | | | |
| 1.8 MPa | | | | | | | | | | | | |

| | | | | |
|---|---|---|---|---|
| T Range^{d} | 75^{e} | 75^{e} | 75^{e} | 75^{e} |
| (° C.) | | | | |
| Curl^{f} | <0.5 | 3.5 | 2 | <0.5 |
| (mm) | | | | |

^{a}Bar type used only for tensile and relative strength testing.
^{b}Values determined according to ISO 180: 2000 method A (ISO 180/A, notched Izod).
^{c}Values determined according to ISO 75-2: 2013 method B.
^{d}T range is temperature range.
^{e}The maximum and minimum temperatures of the range was 295 to 220 C.
^{f}Values obtained using curl bar test.

Table 4 shows the properties of various 3D-printed test samples prepared from AM compositions disclosed herein and which comprise a toughener. All tensile test bars in table 4 were printed flat on the Makergear M2 equipped with a 0.35 mm nozzle under a nitrogen-purged atmosphere at 30 mm/sec at a nozzle temperature of 275° C. and a bed temperature of 85° C. with no cooling fan. Test samples used to determine curl were printed on a Lulzbot TAZ6 equipped with a hexagon extruder and a 0.5 mm nozzle. Tensile data and relative strengths were compared for injection-molded ISO 1A test bars (DAM) and 3D-printed ISO 5A test bars (DAP) (printed flat).

For the temperature range (not dried) results, the cylinders were printed with filaments that had not been dried, but had been sealed in an aluminum bag under vacuum within twenty minutes or less after being produced. Printing was conducted with these filaments at a temperature range from 270 to 170° C., stepping down the temperature by 10° C. in 10 mm increments while printing a hollow cylinder according to the Temperature Range Test. Printing speed was 15 mm/min with no fan and a Lulzbot TAZ6 equipped with a hexagon extruder and a 0.5 mm nozzle was used.

For the temperature range (dry) results, filaments were dried at 90° C. under vacuum for at least 24 h. Printing was conducted with these filaments at a temperature range from 290 to 190° C., stepping down the temperature by 10° C. in 10 mm increments while printing a hollow cylinder according to the Temperature Range Test. Printing speed was 10 mm/min with no fan and a Lulzbot TAZ 6 equipped with a hexagon extruder and a 0.5 mm nozzle was used.

Comparative Example C11 is a commercial blend of nylon 6 and ˜40 wt % of an anhydride-containing ionomeric toughener. Comparative Example C12 is a blend of nylon 6, amorphous polyamide B, and 40 wt % of an anhydride-free zinc-neutralized ionomeric toughener. Examples E23 and E24 are blends of semicrystalline copolyamide PA1 and amorphous copolyamide PA2 with 20 wt % of an anhydride-free zinc-neutralized ionomeric toughener. Example E25 is a blend of semicrystalline copolyamide PA1 and amorphous copolyamide PA2 comprising 40 wt % of an anhydride-containing ionomeric toughener. The tensile data and relative strengths for injection-molded ISO 1A bars and 3D-printed ISO 5A bars of these blends clearly show an advantage of using polyamide/ionomeric toughener blends as disclosed herein, in obtaining an improved balance of tensile properties, particularly of 3D-printed parts, compared to C11 and C12. E23, E24, and E25 all have tensile moduli greater than 1200 MPa for injection-molded ISO 1A bars, along with tensile strengths greater than 36 MPa, strain at break greater than 50%, and relative strengths greater than 20 for dry-as-printed ISO 5A bars, which were printed in a flat orientation. In contrast, tensile measurements for C11 and C12 fall below these values. Curl was about 0.5 mm for E23, E24 and E25, while curl was 1 mm for C11. C12 comprising amorphous polyamide B had a curl value of 0.5 mm, but the composition of C12 in the absence of amorphous polyamide B (60 wt % PA4 and 40 wt % T1) had a curl value of 1.5 mm.

An advantage of using anhydride-free ionomers as the toughener is shown by the temperature range test, in which blends containing anhydride-free ionomer (E23 and E24) could be printed without drying the filament (not dried), whereas E25 comprising an anhydride-containing ionomer could not be printed beyond a few layers without first drying the composition. Upon drying, E23 to E25 printed with a relatively broad temperature range.

The AM compositions of the present invention when toughened by an anhydride-containing ionomer showed superior property retention in printed as compared to dry-as-molded tests parts, as shown by E25. For E25, the printed flat bars retained 98% of the tensile strength, 54% of the strain at break, and 52% of the relative strength of the DAM part. Retention of printed as compared to DAM properties was not as high for C11, the commercial blend of nylon 6 and ˜40 wt % of an anhydride-containing ionomeric toughener. E25 exhibited the highest relative strength for printed bars among the examples and comparative examples reported in table 4.

Tensile strengths of E23, E24 and E25 in table 4 are DAP. When E23 to E25 were conditioned, they had tensile strengths of 38 MPa, 36 MPa, and 53 MPa, respectively, to give wet:dry tensile strength ratios of 0.93, 0.95, and 1.06, respectively.

TABLE 4

| | C11 | | C12 | | E23 | | E24 | | E25 | |
|---|---|---|---|---|---|---|---|---|---|---|
| PA1 | | | | | 64 | | 48 | | 48 | |
| PA2 | | | 12 | | 16 | | 12 | | 12 | |
| PA4 | | | 48 | | | | | | | |
| B1 | 100 | | | | | | | | | |
| T1 | | | 40 | | 20 | | | | | |
| T2 | | | | | | | 40 | | | |
| T3 | | | | | | | | | 40 | |
| Method^{a} | DAM | DAP | DAM | DAP | DAM | DAP | DAM | DAP | DAM | DAP |

Physical Properties

| | | | | | | | | | | |
|---|---|---|---|---|---|---|---|---|---|---|
| Tensile | 1140 | NM | 876 | NM | 1606 | NM | 1248 | NM | 1616 | NM |
| Modulus | | | | | | | | | | |
| (MPa) | | | | | | | | | | |
| Tensile | 40 | 36 | 30 | 25 | 56 | 41 | 53 | 38 | 51 | 50 |
| Strength | | | | | | | | | | |
| (MPa) | | | | | | | | | | |
| Strain at | 220 | 48 | 41 | 21 | 236 | 68 | 228 | 77 | 131 | 71 |
| Break (%) | | | | | | | | | | |
| Relative | 87 | 17 | 10 | 5 | 132 | 27 | 121 | 29 | 67 | 35 |
| Strength | | | | | | | | | | |

| | | | | | |
|---|---|---|---|---|---|
| T Range^{b} | 0 | 30 | 40 | 30 | 0^{d} |
| (not dried) | | (260-230) | (270-230) | (270-240) | |
| T Range^{b} | 50 | 60 | 60 | 50 | 60 |
| (dried) | (290-240) | (290-230) | (290-230) | (280-230) | (290-230) |
| Curl^{c} | 1 mm | 0.5 mm | 0.5 mm | 0.5 mm | 0.5 mm |

NM—Not measured.
^{a}Used only for tensile and relative strength testing.
^{b}Values obtained using temperature range test; all values in ° C.; temperatures in parentheses are maximum and minimum of the temperature range (T range).
^{c}Values obtained using curl bar test.
^{d}Not printable beyond a few layers.

Resins comprising high percent fiber and exhibiting high stiffness are desirable for large scale additive manufacturing. Table 5 shows the properties of examples comprising high glass fiber loadings of the invention described herein with E26 and E27 comprising 30% GF and examples E28-E32 and C13 comprising 50% GF. The tensile bars for E27 and E32 were printed on Lulzbot Mini or Lulzbot TAZ6 printers using a hexagon extruder with a 0.5 mm nozzle and 2.85 mm filament. Printing was conducted under a nitrogen-purged atmosphere at 30 mm/sec at a nozzle temperature of 275° C. and a bed temperature of 85° C. with no cooling fan. The curl bar for E26-E27 was printed under ambient conditions on a Lulzbot TAZ6 equipped with an aerostruder and a 0.5 mm nozzle, using 2.85 mm filament. The injection-molded bars were tested dry-as-molded and the bars for E27 and E32 were tested dry-as-printed.

When Comparative Example C13, which comprises a 50% glass-reinforced nylon 66 composition, was printed on a Big Area Additive Manufacturing (BAAM) machine (Cincinnati Inc.; Harrison, Ohio), the start and stop ends of the 3D printed part were poorly printed, significant drooling was observed, and the part exhibited warpage such that one end was lifted from the print table. Examples E26, E28, and E31 are injection molded articles. While all show similar relative strength (7.4-7.6, respectively), examples E28 and E31 with the higher glass fiber loading exhibit much greater tensile modulus (˜15 GPa to 8.6 GPa for E26) and higher tensile strength (184-191 MPa to 152 MPa for E26). An improvement in impact strength is also noted, with example E28 reflecting a 13% improvement and example E30 a 41% improvement in notched IZOD impact strength over example E26. Compositions containing 50% GF from E31 were made into filament and wound onto spools for 3D printing. Compositions from E28 were also tested on large additive manufacturing equipment. Large hexagons were printed on a Large-Scale Additive Manufacturing (LSAM®) machine (Thermwood; Dale, Ind.). The hexagons exhibited good interlayer adhesion, minimum warpage, and good shape retention. Dogbones approximately 1.5 inches wide by 0.5 inches thick were waterjet cut from the hexagons and tested by a non-standard tensile testing method based on ASTM D638. Example E29 retains greater than 90% of the tensile modulus found in the injection molded bar (E28) and exhibits similar tensile strength. The Z-directional strength of this composition is shown in example E30. The ratio of vertical to flat tensile strength is 0.28.

TABLE 5

| | E26 | E27 | E28 | E29 | E30 | E31 | E32 | C13 |
|---|---|---|---|---|---|---|---|---|
| PA1 | 54.36 | | 38.36 | | | 38.88 | | |
| PA2 | 13.59 | | 9.59 | | | 9.72 | | |
| GF1 | 30 | | 50 | | | 50 | | |
| AO1 | 0.5 | | 0.5 | | | | | |
| AO2 | 0.25 | | 0.25 | | | | | |
| MB1 | 1 | | 1 | | | 1 | | |
| HS1 | 0.3 | | 0.3 | | | 0.4 | | |
| F6^{a} | | | | | | | | 100 |
| Bar Type | IM 1A | Flat 1A | IM 1A | LM X^{b} | LM Z^{b} | IM 1A | Flat 5A | IM^{a} |

Physical Properties

| | | | | | | | | |
|---|---|---|---|---|---|---|---|---|
| Tensile | 8647 | 4356 | 15076 | 14040 | 4650 | 15251 | 5055 | 17000 |
| Modulus | | | | | | | | |
| (MPa) | | | | | | | | |
| Tensile | 152 | 77 | 184 | 181 | 50 | 191 | 91 | 240 |
| Stress | | | | | | | | |
| (MPa) | | | | | | | | |
| Strain at | 4.9 | 2.7 | 4.1 | 2.2 | 1.3 | 4.0 | 3.3 | 2.4 |
| Break (%) | | | | | | | | |
| Relative | 7.4 | 2.1 | 7.5 | 4.0 | 0.6 | 7.6 | 3.0 | 5.8 |
| Strength | | | | | | | | |
| (MPa) | | | | | | | | |
| Impact | 17 | 18 | 20 | | | 25 | 21 | |
| Strength^{b} | | | | | | | | |
| (kJ/m²) | | | | | | | | |

| | | |
|---|---|---|
| Curl^{c} | 0.5 | |
| (mm) | | |
| T Range^{d} | | 40 |
| (° C.) | | (290-250) |

^{a}Physical properties were obtained from technical data sheet.
^{b}Values determined according to ISO 180: 2000 method A (ISO 180/A, notched Izod).
^{c}Values obtained using curl bar test.
^{d}Values obtained using temperature range test: maximum to minimum temperature of the range in parentheses; T range is temperature range.

Table 6 shows compositions comprising mixtures of glass and carbon fibers, ranging from 7.5% to 22.5% glass fiber, as well as 7.5% to 22.5% carbon fiber. All tensile test bars in table 6 were printed on Lulzbot Mini or Lulzbot TAZ6 printers using a hexagon extruder with a 0.5 mm nozzle and 2.85 mm filament. Printing was conducted under a nitrogen-purged atmosphere at 30 mm/sec at a nozzle temperature of 275° C. and a bed temperature of 85° C. with no cooling fan. The bars were tested dry-as-printed. The temperature range test was conducted on the same printers.

Examples E37 and E38 are comprised of polyamides PA1 and PA2 with 22.5% carbon fiber and 7.5% glass fiber. Articles printed from examples E37 show that improvements in modulus (25% improvement over example E9 with 30% GF and 10% improvement over E15 with 20% CF) can be observed with this mixed fiber composition. Similarly, Example E38 has improved modulus (54% and 24%, respectively) when compared to E10 and E16.

TABLE 6

| | Example | | | | | | | | | |
|---|---|---|---|---|---|---|---|---|---|---|
| | E9 | E10 | E15 | E16 | E33 | E34 | E35 | E36 | E37 | E38 |
| PA1 | 53 | | 64 | | 56 | | 56 | | 56 | |
| PA2 | 13.2 | | 16 | | 14 | | 14 | | 14 | |
| GF1 | 30 | | | | 22.5 | | 15 | | 7.5 | |
| CF1 | | | 20 | | 7.5 | | 15 | | 22.5 | |
| AO1 | 0.5 | | | | | | | | | |
| MB1 | 3 | | | | | | | | | |
| HS1 | 0.3 | | | | | | | | | |
| Bar type^{a} | Flat | Edge | Flat | Edge | Flat | Edge | Flat | Edge | Flat | Edge |

Physical Properties

| | | | | | | | | | | |
|---|---|---|---|---|---|---|---|---|---|---|
| Tensile | 3939 | 4613 | 4492 | 5713 | 3265 | 4395 | 3978 | 4873 | 4943 | 7104 |
| Modulus | | | | | | | | | | |
| (MPa) | | | | | | | | | | |
| Tensile | 91 | 101 | 98 | 102 | 59 | 65 | 78 | 73 | 84 | 104 |
| Stress | | | | | | | | | | |
| (MPa) | | | | | | | | | | |
| Strain at | 3.4 | 3.3 | 3.4 | 2.9 | 2.9 | 2.2 | 3.1 | 2.2 | 2.7 | 2.5 |
| Break (%) | | | | | | | | | | |
| Relative | 3.1 | 3.3 | 3.3 | 3.0 | 1.7 | 1.5 | 2.4 | 1.6 | 2.3 | 2.6 |
| Strength | | | | | | | | | | |
| (MPa) | | | | | | | | | | |

| | | | | | |
|---|---|---|---|---|---|
| T Range^{b} | — | 75 | 70 | 70 | 70 |
| (° C.) | | (295-220) | (290-220) | (290-220) | (290-220) |

^{a}Bar type used only for tensile and relative strength testing.
^{b}Values obtained using temperature range test; maximum to minimum temperature of the range in parentheses; T range is temperature range.

Various fillers, including thermally and electrically conductive fillers, can be used with these robust 3D printable resin compositions to achieve a range of properties, as shown in table 7. All tensile test bars in table 7 were printed on a Makergear M2 printer equipped with a 0.5 mm nozzle and using 1.75 mm filament. Printing was conducted under a nitrogen-purged atmosphere at 30 mm/sec at a nozzle temperature of 275° C. and a bed temperature of 85° C. with no cooling fan. Reported measurements are for dry-as-printed bars. Test samples used to determine curl were printed on a Lulzbot TAZ6 equipped with an aerostruder and a 0.5 mm E3D nozzle with printing conditions including no cooling fan, a nozzle temperature of 275° C. and a bed temperature of 85° C. For the temperature range results, a Makergear M2 or M3 equipped with a 0.4 mm nozzle was used. Printing was conducted at a temperature range from 290 to 235° C., stepping down the temperature by 5° C. in 10 mm increments while printing a hollow cylinder according to the Temperature Range Test. Printing speed was 30 mm/sec with no fan and an 85° C. bed temperature.

Examples E39 and E40 are comprised of PA1 and PA2 and boron nitride (AD1), a thermally conductive filler. Articles printed from E39 have improved tensile modulus (91% improvement) over C14, which does not comprise any filler, while retaining good tensile strength. Comparative examples C16 and C17 are comprised of PA2 and nylon 10,10 (PA5) and boron nitride. Curl bars printed from the composition of C16 and C17 exhibit increased curl when compared to compositions of E39 and E40, as well as compared to the compositions of E41 and E42, which comprise PA1 in addition to PA2 and PA5. Articles printed from E41 show similar tensile modulus and tensile strength to articles printed from C16, but articles printed from E41 have greater relative strength (1.3 vs. 1.0 for C16). Tensile bars comprising the compositions of E39, E40, E41 and E42 have improved ratios of vertical to flat tensile strength as compared to the unfilled composition of comparative examples C14 and C15 (0.35 and 0.39, respectively, versus 0.30). Examples E43 and E44 comprise graphite (AD2), which can be a lubricating and thermally conductive filler. Compared to E41, articles printed from E43 show slightly improved relative strength (1.4 versus 1.3) and improved tensile strength (14% improvement), but increased curl. Toughness was similar across the compositions of Table 7.

The ratios of wet:dry tensile moduli and wet:dry tensile strength as obtained for dry-as-printed and conditioned bars were above 0.90 in all instances, indicating the moisture-tolerance of the compositions of the present invention.

TABLE 7

| | Example | | | | | | | | | |
|---|---|---|---|---|---|---|---|---|---|---|
| | C14 | C15 | E39 | E40 | C16 | C17 | E41 | E42 | E43 | E44 |
| PA1 | 80 | | 62.36 | | | | 4.5 | | 4.5 | |
| PA2 | 20 | | 15.59 | | 15.59 | | 12.08 | | 12.08 | |
| PA5 | | | | | 62.36 | | 60.82 | | 60.82 | |
| AO1 | | | 0.5 | | 0.5 | | 0.2 | | 0.2 | |
| AO2 | | | 0.25 | | 0.25 | | | | | |
| AO3 | | | | | | | 0.4 | | 0.4 | |
| MB1 | | | 1 | | 1 | | 1 | | 1 | |
| HS3 | | | 0.3 | | 0.3 | | | | | |
| AD1 | | | 20 | | 20 | | 21 | | | |
| AD2 | | | | | | | | | 21 | |
| Bar type^{a} | Flat | Vertical | Flat | Vertical | Flat | Vertical | Flat | Vertical | Flat | Vertical |
| Tensile | 1712 | 1607 | 3267 | 2496 | 2944 | 2436 | 2959 | 2055 | 2229 | 2005 |
| Modulus | | | | | | | | | | |
| (MPa) | | | | | | | | | | |
| Tensile | 54 | 16 | 52 | 18 | 42 | 23 | 44 | 17 | 50 | 13 |
| Stress | | | | | | | | | | |
| (MPa) | | | | | | | | | | |
| Strain at | 3.6 | 1.0 | 2.6 | 0.9 | 2.3 | 1.4 | 3.0 | 1.0 | 2.9 | 0.6 |
| Break (%) | | | | | | | | | | |
| Relative | 1.9 | 0.2 | 1.3 | 0.2 | 1.0 | 0.3 | 1.3 | 0.2 | 1.4 | 0.1 |
| Strength | | | | | | | | | | |
| (MPa) | | | | | | | | | | |
| Wet:Dry | 0.98 | | 0.92 | | 0.96 | | 0.95 | | 0.91 | |
| Tensile | | | | | | | | | | |
| Moduli | | | | | | | | | | |
| Wet:Dry | 0.97 | | 0.94 | | 0.98 | | 0.92 | | 0.92 | |
| Tensile | | | | | | | | | | |
| Strength | | | | | | | | | | |
| Impact | 15 | | 15 | | | | 15 | | 15 | |
| Strength^{b} | | | | | | | | | | |
| (kJ/m²) | | | | | | | | | | |

| | | | | | |
|---|---|---|---|---|---|
| Curl^{c} | <0.5 | <0.5 | 2.5 | 1.2 | 3 |
| (mm) | | | | | |
| T Range^{d} | 55 | 55 | 55 | 55 | 55 |
| (° C.) | (290-235) | (290-235) | (290-235) | (290-235) | (290-235) |

^{a}Bar type used only for tensile and relative strength testing.
^{b}Values determined according to ISO 180: 2000 method U (ISO 180/U, unnotched Izod).
^{c}Values obtained using curl bar test.
^{d}Values obtained using temperature range test: maximum to minimum temperature of the range in parentheses; T range is temperature range..

In 3D printed parts, significant anisotropy can be observed when measuring the tensile strength and tensile modulus of a part printed in different directions. Table 8 and Table 9 show efforts to reduce the anisotropy of 3D-printed articles. All tensile bars in tables 8 and 9 were printed on Lulzbot Mini or Lulzbot TAZ6 printers using a hexagon extruder with a 0.5 mm nozzle and 2.85 mm filament. Printing was conducted under a nitrogen-purged atmosphere at 30 mm/sec at a nozzle temperature of 275° C. and a bed temperature of 85° C. with no cooling fan. Bars were tested dry-as-printed. Test samples used to determine curl were printed on a Lulzbot TAZ6 equipped with an aerostruder and a 0.5 mm E3D nozzle with printing conditions including no cooling fan, a nozzle temperature of 275° C. and a bed temperature of 85° C. For the temperature range results, a Makergear M2 or M3 equipped with a 0.4 mm nozzle was used. Printing was conducted at a temperature range from 290 to 235° C., stepping down the temperature by 5° C. in 10 mm increments while printing a hollow cylinder according to the Temperature Range Test. Printing speed was 30 mm/sec with no fan and an 85° C. bed temperature.

For E45, E10, and E46, comprising primarily PA1, PA2, and GF1, articles printed flat with an infill of “0/180” degrees (Flat 0/180) show significant improvement in tensile modulus (+67%) and tensile stress (+69%) versus articles printed flat with an infill of “45/−45” degrees (Flat 45/−45; E9). Articles printed on edge, but with an infill of “45/−45” degrees (Edge 45-/45; E10) show mild improvements in tensile modulus (+17%) and tensile stress (+11%) versus Flat “45/−45” degree articles. Articles printed on edge, but with an infill of “0/180” degrees (Edge 0/180; E46) show mild improvement in tensile modulus (+10%) with a mild decrease in tensile stress (−11%) versus Flat “45/−45” degree articles.

TABLE 8

| | Example | | | | | | | | | | | |
|---|---|---|---|---|---|---|---|---|---|---|---|---|
| | E9 | E45 | E10 | E46 | E47 | E48 | E49 | E50 | E51 | E52 | E53 | E54 |
| PA1 | 53 | | | | 54.36 | | | | 38.36 | | | |
| PA2 | 13.2 | | | | 13.59 | | | | 9.59 | | | |
| GF1 | 30 | | | | | | | | 30 | | | |
| GF2 | | | | | 30 | | | | 20 | | | |
| AO1 | 0.5 | | | | 0.5 | | | | 0.5 | | | |
| AO2 | | | | | 0.25 | | | | 0.25 | | | |
| MB1 | 3 | | | | 1 | | | | 1 | | | |
| HS1 | 0.3 | | | | 0.3 | | | | 0.3 | | | |
| Bar type^{a} | Flat | Flat | Edge | Edge | Flat | Flat | Edge | Edge | Flat | Flat | Edge | Edge |
| | | 0/180 | | 0/180 | | 0/180 | | 0/180 | | 0/180 | | 0/180 |
| Physical Properties | | | | | | | | | | | | |
| Tensile | 3939 | 6567 | 4613 | 4347 | 2503 | 2678 | 2671 | 2631 | 4301 | 5928 | 4579 | 5031 |
| Modulus | | | | | | | | | | | | |
| (MPa) | | | | | | | | | | | | |
| Tensile | 91 | 153 | 101 | 81 | 57^{b} | 52^{b} | 59^{b} | 62^{b} | 88 | 116 | 78 | 83 |
| Stress | | | | | | | | | | | | |
| (MPa) | | | | | | | | | | | | |
| Strain at | 3.4 | 3.4 | 3.3 | 2.5 | 9.0^{b} | 12.9^{b} | 7.8^{b} | 6.5^{b} | 3.2 | 3.2 | 2.4 | 2.5 |
| Break (%) | | | | | | | | | | | | |
| Relative | 3.1 | 5.3 | 3.3 | 2.0 | 5.1 | 6.8 | 4.7 | 4.0 | 2.8 | 3.6 | 1.8 | 2.0 |
| Strength | | | | | | | | | | | | |
| (MPa) | | | | | | | | | | | | |
| Impact | | | 20 | | | | 4 | | | | 15 | |
| Strength^{c} | | | | | | | | | | | | |
| (kJ/m²) | | | | | | | | | | | | |
| HDT^{d} | | | 169 | | | | | | | | | |
| (° C.) at | | | | | | | | | | | | |
| 0.45 MPa | | | | | | | | | | | | |
| HDT^{d} | | | 106 | | | | | | | | | |
| (° C.) at | | | | | | | | | | | | |
| 1.8 MPa | | | | | | | | | | | | |

| | | | |
|---|---|---|---|
| Curl^{e} | 0.5^{g} | 0.5 | <0.5 |
| (mm) | | | |
| T Range^{f} | 55 | 40 | 55 |
| (° C.) | (290-235)g | (290-250) | (290-235) |

^{a}Bar type used only for tensile and relative strength testing.
^{b}Bars pulled at a secondary test speed of 50 mm/min due to their ductility.
^{c}Values determined according to ISO 180: 2000 method A (ISO 180/A, notched Izod).
^{d}Values determined according to ISO 75-2: 2013 method B.
^{e}Values obtained using curl bar test.
^{f}Values obtained using temperature range test; maximum to minimum temperature of the range in parentheses; T range is temperature range.
^{g}Curl and temperature range were obtained for an analogous composition containing 1 wt % MB1.

Glass beads such as GF2 can be incorporated to reduce this anisotropy. Examples E48, E49, and E50 are a polyamide composition comprising 30% glass beads. As shown in tables 8 and 9, the anisotropy in tensile modulus and tensile stress for these examples is reduced to less than or equal to 10% of the flat 45/−45 degree values (E47). Test bars printed from E48 (flat 0/180) show a mild improvement in tensile modulus (+7%) and mild reduction in tensile stress (−8%) compared to test bars printed flat at 45/−45 degrees, which is a significant reduction in anisotropy versus standard glass-fiber filled compositions. These articles also reflect significantly improved ductility when incorporating glass beads GF2 (6.5-12.9% strain at break) as compared to standard glass fiber GF1 (2.5-3.4% strain at break). The composition of examples E51, E52, E53 and E54 comprises primarily PA1, PA2, GF1, and GF2 with the combined loading of glass fiber and glass beads comprising 50% of the composition, and the mechanical properties reflect a balance between the properties of compositions comprising only glass fiber or only glass beads as the filler. Articles printed from the composition of E51, E52, E53 and E54 retain similar tensile properties to E9, but do not otherwise exhibit similar anisotropy when printed in different directions. The maximum mean deviation from the Flat 45/−45 degree properties is a 38% improvement in tensile modulus when printed in a Flat 0/180 direction (E52, Table 9).

TABLE 9

| | Percent Difference from Flat 45/−45 Degree 3D Printed Bars | | | | | | | | |
|---|---|---|---|---|---|---|---|---|---|
| | Example | | | | | | | | |
| | E45 | E10 | E46 | E48 | E49 | E50 | E52 | E53 | E54 |
| Descrip- | 30% | 30% | 30% | 30% | 30% | 30% | 30% | 30% | 30% |
| tion | GF | GF | GF | GB | GB | GB | GF, | GF, | GF, |
| | | | | | | | 20% | 20% | 20% |
| | | | | | | | GB | GB | GB |
| Bar Type | Flat | Edge | Edge | Flat | Edge | Edge | Flat | Edge | Edge |
| | 0/180 | 45/−45 | 0/180 | 0/180 | 45/−45 | 0/180 | 0/180 | 45/−45 | 0/180 |
| Tensile | +67% | +17% | +10% | +7% | +7% | +5% | +38% | +6% | +17% |
| Modulus | | | | | | | | | |
| (MPa) | | | | | | | | | |
| Tensile | +69% | +11% | −11% | −8% | +5% | +10% | +31% | −12% | −6% |
| Stress | | | | | | | | | |
| (MPa) | | | | | | | | | |
| Strain at | +1% | −3% | −27% | +43% | −13% | −28% | −1% | −25% | −23% |
| Break (%) | | | | | | | | | |

Tougheners also improve the mechanical properties of printable compositions. Table 10 shows compositions comprising unfunctionalized and functionalized ethylene/alpha-olefin copolymers as tougheners. All tensile bars in table 10 were printed on a Makergear M2 printer equipped with a 0.5 mm nozzle and using 1.75 mm filament. Printing was conducted under a nitrogen-purged atmosphere at 30 mm/sec at a nozzle temperature of 275° C. and a bed temperature of 85° C. with no cooling fan. Results are reported for dry-as-printed bars. Test samples used to determine curl were printed on a Lulzbot TAZ6 equipped with an aerostruder and a 0.5 mm E3D nozzle with printing conditions including no cooling fan, a nozzle temperature of 275° C. and a bed temperature of 85° C. For the temperature range results, a Makergear M2 or M3 equipped with a 0.4 mm nozzle was used. Filaments were dried at 90° C. under vacuum for at least 24 h prior to use. Printing was conducted at a temperature range from 290 to 235° C., stepping down the temperature by 5° C. in 10 mm increments while printing a hollow cylinder according to the Temperature Range Test. Printing speed was 30 mm/sec with no fan and an 85° C. bed temperature.

Example E55, a polyamide composition comprising an unfunctionalized ethylene/1-octene copolymer T9 as the toughener, shows improved relative strength (2.5) when compared to C14, which does not incorporate a toughener (relative strength of 1.9). The impact strength of E55 is 1.4× higher than C14. However, E56 shows that the unfunctionalized, nonpolar nature of this toughener has a deleterious effect on the tensile strength of vertically-printed articles. Addition of a second functional impact modifier, such as a maleic anhydride grafted ethylene/1-octene copolymer T8, to the polyamide composition along with T9 produces the composition of E57 and E58, which exhibit a marked improvement in relative strength (24.4) compared to C14. Moreover, the ratio of vertical to flat tensile strength is improved for E58 (0.35) relative to C14 (0.30) and E56 (0.23). Remarkably, impact strength for E57 relative to C14 is increased tenfold, and approximately 7.4× greater than E55. Shifting to the composition of E59 and E60, which primarily comprises PA1, PA2, and functional toughener T8, boosts the tensile properties further without greatly affecting the impact strength. The relative strength of E59 increases to 6.8 owing to much improved strain at break (89%), while sustaining the same ratio of vertical to flat tensile strength of 0.35 as E58. Use of maleic anhydride grafted ethylene/1-butene copolymer T10 as the toughener affords even greater relative strength (41.6) while maintaining a ratio of vertical to flat tensile strength of 0.37. Overall, the addition of the functionalized toughener to the polyamide composition has a slight penalty on tensile strength of 3D printed articles while otherwise improving toughness, vertical tensile strength, ductility and interlayer adhesion.

The incorporation of functionalized tougheners gave higher ratios of both wet:dry tensile moduli and strength than the incorporation of the nonfunctionalized toughener, providing ratios similar to that of the untoughened composition of C14. Curl was low, at 1 mm or less, for all compositions reported in table 10.

TABLE 10

| | Example | | | | | | | | | |
|---|---|---|---|---|---|---|---|---|---|---|
| | C14 | C15 | E55 | E56 | E57 | E58 | E59 | E60 | E61 | E62 |
| PA1 | 80 | | 62.88 | | 62.88 | | 62.88 | | 62.88 | |
| PA2 | 20 | | 15.72 | | 15.72 | | 15.72 | | 15.72 | |
| HS1 | | | 0.4 | | 0.4 | | 0.4 | | 0.4 | |
| MB1 | | | 1 | | 1 | | 1 | | 1 | |
| T8 | | | | | 10 | | 20 | | | |
| T9 | | | 20 | | 10 | | | | | |
| T10 | | | | | | | | | 20 | |
| Bar type^{a} | Flat | Vertical | Flat | Vertical | Flat | Vertical | Flat | Vertical | Flat | Vertical |
| Tensile | 1712 | 1607 | 1248 | 883 | 1146 | 1030 | 1110 | 973 | 1104 | 925 |
| Modulus | | | | | | | | | | |
| (MPa) | | | | | | | | | | |
| Tensile | 54 | 16 | 38 | 9 | 37 | 13 | 41 | 15 | 41 | 15 |
| Stress | | | | | | | | | | |
| (MPa) | | | | | | | | | | |
| Strain at | 3.6 | 1.0 | 6.8 | 0.9 | 65.3 | 1.3 | 88.9 | 1.5 | 101.5 | 1.7 |
| Break (%) | | | | | | | | | | |
| Relative | 1.9 | 0.2 | 2.5 | 0.1 | 24.4 | 0.2 | 36.8 | 0.2 | 41.6 | 0.2 |
| Strength | | | | | | | | | | |
| (MPa) | | | | | | | | | | |
| Relative | 282 | 22 | 368 | 11 | 3546 | 24 | 5341 | 32 | 6037 | 36 |
| Strength | | | | | | | | | | |
| (psi) | | | | | | | | | | |
| Vertical: | — | 0.30 | — | 0.23 | — | 0.35 | — | 0.35 | — | 0.37 |
| Flat | | | | | | | | | | |
| Tensile | | | | | | | | | | |
| Strength | | | | | | | | | | |
| Wet:Dry | 0.98 | — | 0.94 | — | 0.96 | — | 0.97 | — | 0.97 | — |
| Tensile | | | | | | | | | | |
| Moduli | | | | | | | | | | |
| Wet:Dry | 0.97 | — | 0.91 | — | 0.92 | — | 0.96 | — | 0.97 | — |
| Tensile | | | | | | | | | | |
| Strength | | | | | | | | | | |
| Impact | 15 | — | 21 | — | 156 | — | 151 | — | 154 | — |
| Strength^{b} | | | | | | | | | | |
| (kJ/m²) | | | | | | | | | | |

| | | | | | |
|---|---|---|---|---|---|
| Curl^{c} | <0.5 | 1 | 1 | 0.8 | 0.5 |
| (mm) | | | | | |
| T Range^{d} | 55 | 55 | 50 | 45 | 55 |
| (° C.) | (290-235) | (290-235) | (290-240) | (290-245) | (290-235) |

^{a}Bar type used only for tensile and relative strength testing.
^{b}Values determined according to ISO 180: 2000 method U (ISO 180/U, unnotched Izod).
^{c}Values obtained using curl bar test.
^{d}Values obtained using temperature range test; maximum to minimum temperature of the range in parentheses; T range is temperature range..

Table 11 shows the properties of 3D printed test bars of compositions comprising tougheners with the nozzle temperature at 290° C., as compared to the 275° C. nozzle temperature of the examples comprising tougheners of tables 4 and 10. All tensile bars in table 11 were printed in flat and vertical orientations, and all impact bars were printed in a flat orientation, on a Makergear M2 printer equipped with a 0.5 mm nozzle and using 1.75 mm filament. Data for the flat bars is reported in table 11 along with the ratio of vertical to flat tensile strength. Printing was conducted under a nitrogen-purged atmosphere at 30 mm/sec at a nozzle temperature of 290° C. and a bed temperature of 85° C. with no cooling fan. Results are reported for dry-as-printed bars.

Test samples used to determine curl were printed on a Lulzbot TAZ6 equipped with an aerostruder and a 0.5 mm E3D nozzle with printing conditions including no cooling fan, a nozzle temperature of 275° C. and a bed temperature of 85° C. For the temperature range results, a Makergear M2 or M3 equipped with a 0.4 mm nozzle was used. Filaments were dried at 90° C. under vacuum for at least 24 h prior to use. Printing was conducted with these filaments at a temperature range from 290 to 235° C., stepping down the temperature by 5° C. in 10 mm increments while printing a hollow cylinder according to the Temperature Range Test. Printing speed was 30 mm/sec, unless specified otherwise, with no fan and an 85° C. bed temperature.

Test bars printed from the composition in E63, comprising just 5 weight percent of anhydride functionalized ethylene acrylate copolymer T11 as the toughener, retains the tensile properties of untoughened composition C18 but improves the ratio of vertical to flat tensile strength (0.55 for E63 versus 0.50 for C18) and greatly improves impact strength by more than 7× (from 18 kJ/m² to 127 kJ/m²). E63 retains the low curl of C18 (<0.5 mm).

Relative strength and impact strength are improved by use of 30 wt % maleic anhydride grafted ethylene/l-octene copolymer T8 as the toughener in E64. Owing to excellent strain at break (114.4%), E64 has a relative strength (41.3) far better than C18 (4.8), as well as an improved ratio of vertical to flat tensile strength of 0.55. Impact strength is increased over 6× compared to C18 (114 vs 18 kJ/m²). However, curl for E64 with 30 wt % T8 is increased over C18 (3.5 mm versus <0.5 mm) and over E59 with 20 wt % T8 (0.8 mm). In addition, tensile modulus is decreased for E64 as compared to C18 and E59 (840 vs 1574 and 1110 MPa). The tensile and curl results of E64 and E59 with 30 wt % and 20 wt % of T8, respectively, and nozzle temperatures of 290° C. and 275° C., respectively, indicate that optimization of tensile and curl properties can be achieved by tuning toughener concentration of T8 to less than 30 wt % and nozzle temperature to greater than 275° C.

Tougheners that act as compatibilizing agents can also be incorporated into the AM compositions. These agents may serve to improve interfacial adhesion in blends of polyamides and ionomeric tougheners. Example E70 comprises AM compositions with ionomeric toughener T1 and compatibilizing toughener T12 at a combined concentration of 20 wt %. This composition retains similar tensile modulus and stress to an AM composition comprising solely T1 at 20 wt % (E69). Example E70 has lower relative strength (11 versus 24.5 for E69), primarily due to lower strain at break (26% versus 60.9% for E69) and increased curl (2.8 mm vs <0.5 mm). A slight uptick in ratio of vertical to flat tensile strength (0.40 in E70 to 0.39 for E69) is observed. The effect of this compatibilizing agent is best evidenced by an uptick in impact strength in E70 (179 kJ/m²) versus E69 (168 kJ/m²). Either composition is a dramatic improvement in toughness compared to C18, with E70 demonstrating a greater than 9.9× increase in impact strength. Example E71 comprises ionomeric toughener T1 and compatibilizing toughener T13. This composition also has lower relative strength (5.2) versus a composition comprising only T1. A lower strain at break (12.7%) is again responsible for this effect. Impact strength is similar to E69 and curl is slightly increased (1 mm vs <0.5 mm). Nonetheless, the use of compatibilizing toughener T13 yields a meaningful improvement in ratio of vertical to flat tensile strength of 0.47, compared to 0.39 for E69. At 179 and 171 kJ/m², not only are the impact strengths of E70 and E71 higher than that of E69 without a compatibilizing toughener (168 kJ/m2), but these values are the highest impact strengths reported in table 11. At an impact strength of 168 kJ/m² and curl of less than 0.5 mm, E69 at just 20 wt % T1 has an improved balance of impact strength and curl has compared to the examples of table 11 comprising 40 wt % (E67, E68, E72, E73) anhydride-free ionomeric tougheners. Impact strength of E69 and tensile properties are improved over those of E74 comprising 30 wt % of the same ionomeric toughener T1. These results suggest that optimization of impact, tensile and curl properties of printed test bars can be achieved by tuning ionomeric toughener concentration to less than 30 wt %.

While flat test bars comprised of B1, which is a commercial blend of nylon 6 and anhydride-containing ionomer, exhibit good relative strength (26.8) and impact strength (180 kJ/m²), as reported in comparative example C19, vertically-printed articles have very poor interlayer adhesion and delaminate rapidly upon tensile testing. Vertical articles printed from C19 have a relative strength of only 0.05, due to a low strain at break (0.8%) and low tensile strength (6 MPa). Compared to C19, example E66, which comprises a polyamide composition of the present invention and an ionomeric toughener modified with maleic anhydride methyl ester T3, has greater relative strength (34.9) due to higher tensile strength and strain at break. The ratio of vertical to flat tensile strength is more than doubled (from 0.16 to 0.36) when comparing E66 to C19. E66 has significantly lower curl than C19 (<0.5 mm versus 2.5 mm). Toughness is negatively impacted, with E66 having 76% of the impact strength of C19. Despite both compositions having approximately the same wt % of a structurally similar functionalized ionomer, the blend of polyamides PA1 and PA2 with T3 is clearly superior when considering a balance of properties. When compared to ionomer tougheners lacking this additional functionality, such as E67, which comprises ionomeric toughener T6, E67 has slightly lower relative strength than E66 (32.6 versus 34.9) and lower ratio of vertical to flat tensile strength (0.28 versus 0.36) but greater impact strength (166 versus 137 kJ/m²). Similarly, E68 comprising ionomeric toughener T7, which does not have the anhydride functionality, shows lower yet relative strength (23.2), lower vertical to flat tensile strength (0.28), and lower impact strength (127 kJ/m²). E67 and E68 have higher curl than E66 (2.8 mm and 1.8 mm versus <0.5 mm).

Compositions comprising butyl ester ter-ionomeric toughener T4 are especially promising. Example E65 with T4 at 20 wt % has reasonable tensile properties (37 MPa tensile stress and relative strength of 9.5) and impact strength (153 kJ/m²) that compare well versus C18. However, it is the interlayer adhesion strength added by T4 that makes this composition unique. The composition of E65 has exceptional retention of flat tensile strength when printed in the vertical direction (30 MPa; 0.81 ratio of vertical to flat tensile strength).

The composition of E72 comprises sodium ionomeric toughener T2, which is similar in composition to the zinc ionomeric toughener T5 of E73. The ratio of vertical to flat tensile strength is lower for the sodium-containing composition of E72 as compared to the zinc-containing composition of E73. Moreover, the impact strength afforded to the compositions by these tougheners differs dramatically. E73 has nearly twice the impact strength (171 kJ/m²) as example E72 (100 kJ/m²), reflecting the advantage of the zinc-neutralized ionomer.

Comparative example C20 shows the advantage of the polyamide compositions of the present invention in reducing warpage. In the absence of amorphous copolyamide PA2, C20 exhibited the highest curl (4 mm) reported in table 11. In all instances for the examples of Table 11, the ratios of wet:dry tensile moduli and wet:dry tensile strength were greater than 0.90.

TABLE 11

| | Example | | | | | | | |
|---|---|---|---|---|---|---|---|---|
| | C18 | E63 | E64 | E65 | E66 | C19 | E67 | E68 |
| PA1 | 80 | 76 | 54.88 | 64 | 48 | | 48 | 48 |
| PA2 | 20 | 19 | 13.72 | 16 | 12 | | 12 | 12 |
| HS1 | | | 0.4 | | | | | |
| MB1 | | | 1 | | | | | |
| T1 | | | | | | | | |
| T2 | | | | | | | | |
| T3 | | | | | 40 | | | |
| T4 | | | | 20 | | | | |
| T5 | | | | | | | | |
| T6 | | | | | | | 40 | |
| T7 | | | | | | | | 40 |
| T8 | | | 30 | | | | | |
| T11 | | 5 | | | | | | |
| T12 | | | | | | | | |
| T13 | | | | | | | | |
| B1 | | | | | | 100 | | |
| Tensile | 1574 | 1608 | 840 | 1271 | 1291 | 1121 | 986 | 862 |
| Modulus | | | | | | | | |
| (MPa) | | | | | | | | |
| Tensile | 47 | 46 | 36 | 37 | 44 | 39 | 35 | |
| Stress | | | | | | | | |
| (MPa) | | | | | | | | |
| Strain at | 10.2 | 10.3 | 114.4 | 25.5 | 78.9 | 68.9 | 93.1 | 70.0 |
| Break (%) | | | | | | | | |
| Relative | 4.8 | 4.7 | 41.3 | 9.5 | 34.9 | 26.8 | 32.6 | 23.2 |
| Strength | | | | | | | | |
| (MPa) | | | | | | | | |
| Vertical: | 0.50 | 0.55 | 0.55 | 0.81 | 0.36 | 0.16 | 0.28 | 0.24 |
| Flat | | | | | | | | |
| Tensile | | | | | | | | |
| Strength | | | | | | | | |
| Wet:Dry | 1.21 | 1.02 | 1.01 | 0.97 | 0.98 | 0.91 | 0.99 | 0.94 |
| Tensile | | | | | | | | |
| Moduli | | | | | | | | |
| Wet:Dry | 1.14 | 0.98 | 0.99 | 0.91 | 0.95 | 0.95 | 0.97 | 0.98 |
| Tensile | | | | | | | | |
| Strength | | | | | | | | |
| Impact | 18 | 127 | 114 | 153 | 137 | 180 | 166 | 127 |
| Strength^{a} | | | | | | | | |
| (kJ/m²) | | | | | | | | |
| Curl^{b} | <0.5 | <0.5 | 3.5 | 0.8 | <0.5 | 2.5 | 2.8 | 1.8 |
| (mm) | | | | | | | | |
| T Range^{c} | 55 | 55 | 40 | 55 | 45 | 55 | 55 | 55 |
| (° C.) | (290-235) | (290-235) | (290-250) | (290-235) | (290-245) | (290-235) | (290-235) | (290-235) |
| | | Example | | | | | | |
| | | E69 | E70 | E71 | E72 | E73 | C20 | E74 |
| | PA1 | 64 | 64 | 64 | 48 | 48 | 60 | 56 |
| | PA2 | 16 | 16 | 16 | 12 | 12 | | 14 |
| | HS1 | | | | | | | |
| | MB1 | | | | | | | |
| | T1 | 20 | 16 | 16 | | | 40 | 30 |
| | T2 | | | | 40 | | | |
| | T3 | | | | | | | |
| | T4 | | | | | | | |
| | T5 | | | | | 40 | | |
| | T6 | | | | | | | |
| | T7 | | | | | | | |
| | T8 | | | | | | | |
| | T11 | | | | | | | |
| | T12 | | 4 | | | | | |
| | T13 | | | 4 | | | | |
| | B1 | | | | | | | |
| | Tensile | 1274 | 1360 | 1378 | 1180 | 835 | 768 | 1204 |
| | Modulus | | | | | | | |
| | (MPa) | | | | | | | |
| | Tensile | 40 | 42 | 41 | 43 | 37 | 31 | 40 |
| | Stress | | | | | | | |
| | (MPa) | | | | | | | |
| | Strain at | 60.9 | 26 | 12.7 | 58.2 | 89.6 | 37.6 | 23.9 |
| | Break (%) | | | | | | | |
| | Relative | 24.5 | 11.0 | 5.2 | 25.0 | 33.2 | 11.7 | 9.6 |
| | Strength | | | | | | | |
| | (MPa) | | | | | | | |
| | Vertical: | 0.39 | 0.40 | 0.47 | 0.11 | 0.20 | — | 0.16 |
| | Flat | | | | | | | |
| | Tensile | | | | | | | |
| | Strength | | | | | | | |
| | Wet:Dry | 0.99 | 1.02 | 1.04 | 1.01 | 1.10 | — | 0.98 |
| | Tensile | | | | | | | |
| | Moduli | | | | | | | |
| | Wet:Dry | 0.96 | 0.96 | 0.94 | 1.00 | 1.00 | — | 0.91 |
| | Tensile | | | | | | | |
| | Strength | | | | | | | |
| | Impact | 168 | 179 | 171 | 100 | 171 | 129 | 141 |
| | Strength^{a} | | | | | | | |
| | (kJ/m²) | | | | | | | |
| | Curl^{b} | <0.5 | 2.8 | 1 | 1.1 | 2.8 | 4 | <0.5 |
| | (mm) | | | | | | | |
| | T Range^{c} | 55 | 55 | 55 | 45 | 55 | 30^{d} | 45 |
| | (° C.) | (290-235) | (290-235) | (290-235) | (290-245) | (290-235) | (280-250) | (290-245) |

^{a}Values determined according to ISO 180: 2000 method U (ISO 180/U, unnotched Izod).
^{b}Values obtained using curl bar test.
^{c}Values obtained using temperature range test; maximum to minimum temperature of the range in parentheses; T range is temperature range.
^{d}Printing speed was 15 mm/sec. At the typical printing speed of 30 mm/sec, the temperature range was 0.

The compositions described herein retain their tensile properties after exposure to damp environments. Table 12 shows dry-as-molded and conditioned tensile properties of injection molded ISO 1A bars from a polyamide composition comprised of 30% glass fiber, optionally with additives, such as carbon black colorants, antioxidants, and heat stabilizers (E75), as well as a polyamide composition comprised of 20% carbon fiber (E76). Bars were conditioned by exposing dry-as-molded articles to a 50% relative humidity environment for at least 48 hours prior to tensile testing. The tensile properties vary only slightly with conditioning in E75, with the modulus changing very slightly from 8,975 MPa to 8,838 MPa, the tensile stress dropping by less than 10% from 150 MPa to 137 MPa, and elongation at break slightly increasing, changing from 4.5% to 4.8%. The carbon-fiber composition in E76 shows a slightly greater moisture effect, though the property changes remain minor. A slightly greater drop in tensile modulus is noted (from 13,296 MPa to 12,846 MPa), a mild increase in elongation at break from plasticization occurs (from 3.4% to 3.6%), and tensile stress is decreased by approximately 10% from 156 to 141 MPa. In both E75 and E76, the ratio of wet:dry tensile moduli is greater than or equal to 0.97 and the ratio of wet:dry tensile stress is greater than or equal to 0.90.

TABLE 12

| Example | E75 | | E76 | |
|---|---|---|---|---|
| PA1 | 54.36 | | 64 | |
| PA2 | 13.59 | | 16 | |
| GF1 | 30 | | | |
| CF1 | | | 20 | |
| AO1 | 0.5 | | | |
| AO2 | 0.25 | | | |
| MB1 | 1 | | | |
| HS1 | 0.3 | | 64 | |
| Method | DAM | Cond | DAM | Cond |
| Tensile Modulus (MPa) | 8975 | 8838 | 13296 | 12846 |
| Tensile Stress (MPa) | 150 | 137 | 156 | 141 |
| Strain at Break (%) | 4.5 | 4.8 | 3.4 | 3.6 |
| Relative Strength (MPa) | 6.8 | 6.6 | 5.3 | 5.0 |

| | | |
|---|---|---|
| Wet:Dry Tensile Moduli | 0.98 | 0.97 |
| Wet:Dry Tensile Stress | 0.91 | 0.90 |

Toughened AM compositions can be reinforced with fillers, such as glass fibers, to improve tensile strength. Table 13 shows the effect of adding a toughener to a 30% glass fiber reinforced polyamide composition comprising heat stabilizers, colorants, and additives. Test bars for E55 and E79 were printed on a Makergear M2 printer equipped with a 0.5 mm nozzle and using 1.75 mm filament. The nozzle temperature was 275° C. Test bars for E77, E78 and E80 were printed on a Lulzbot Mini or TAZ6 printer equipped with a 0.5 mm nozzle and hexagon extruder and using 2.85 mm filament. The nozzle temperature was 275° C. for E77 and 285° C. for E78 and E80. Data for the flat bars is reported in table 13 along with the ratio of vertical to flat tensile strength. Printing was conducted under a nitrogen-purged atmosphere at 30 mm/sec at a bed temperature of 85° C. with no cooling fan. Results are reported for dry-as-printed bars.

Test samples used to determine curl were printed on a Lulzbot TAZ6 equipped with an aerostruder and a 0.5 mm E3D nozzle with printing conditions including no cooling fan, a nozzle temperature of 275° C. and a bed temperature of 85° C. For the temperature range results, a Makergear M2 or M3 equipped with a 0.4 mm nozzle was used for E55 and E79 at nozzle temperatures ranging from 290 to 235° C. and a print speed of 30 mm/sec, and a Lulzbot Mini equipped with a 0.5 mm nozzle and hexagon extruder was used for E77, E78 and E80 with nozzle temperatures ranging from 285 to 230° C. and a print speed of 15 mm/sec. Temperatures were stepped down by 5° C. in 10 mm increments while printing a hollow cylinder according to the Temperature Range Test. No fan and an 85° C. bed temperature were used.

Example E77 has a tensile stress of 100 MPa and a relative strength of 3.5. Example E55, which comprises a nonfunctionalized toughener but does not comprise a reinforcing agent, exhibits similar vertical:flat tensile strength ratio (0.2) as E77, but lower tensile strength (38 MPa). Addition of GF1 into the composition, as in E78, does not impact the ratio of vertical:flat tensile strength nor the impact strength (21 kJ/m²) but improves the tensile strength to 62 MPa. Similarly, E79, a toughened polyamide composition without a reinforcing agent comprising both functionalized and nonfunctionalized tougheners, has good impact strength (87 kJ/m²) and vertical:flat tensile strength (0.3) but low tensile stress (40 MPa). Tensile properties can be improved by addition of GF1, as shown by E80. Despite a significant drop in impact strength (to 42 kJ/m²), the tensile stress increases to 70 MPa and vertical:flat tensile strength is retained (0.3). Thus, the properties of toughened resins can be tuned to balance impact strength and tensile properties by adding reinforcing agents, while retaining good interlayer adhesion.

TABLE 13

| | E77 | E55 | E78 | E79 | E80 |
|---|---|---|---|---|---|
| PA1 | 54.36 | 62.88 | 38.88 | 66.88 | 42.88 |
| PA2 | 13.59 | 15.72 | 9.72 | 16.72 | 10.72 |
| GF1 | 30 | | 30 | | 30 |
| T8 | | | | 10 | 10 |
| T9 | | 20 | 20 | 5 | 5 |
| AO1 | 0.5 | | | | |
| AO2 | 0.25 | | | | |
| MB1 | 1 | 1 | 1 | 1 | 1 |
| HS1 | 0.3 | 0.4 | 0.4 | 0.4 | 0.4 |
| Tensile | 4318 | 1248 | 2952 | 1311 | 3034 |
| Modulus | | | | | |
| (MPa) | | | | | |
| Tensile | 100 | 38 | 62 | 40 | 70.3 |
| Stress | | | | | |
| (MPa) | | | | | |
| Strain at | 3.5 | 6.8 | 4.2 | 52.2 | 6.2 |
| Break (%) | | | | | |
| Relative | 3.5 | 2.5 | 2.6 | 21.0 | 4.4 |
| Strength | | | | | |
| (MPa) | | | | | |
| Vertical:Flat | 0.2 | 0.2 | 0.2 | 0.3 | 0.3 |
| Tensile | | | | | |
| Strength | | | | | |
| Impact | | 21 | 21 | 87 | 42 |
| Strength^{a} | | | | | |
| (kJ/m²) | | | | | |
| Curl^{b} | 0.5 | 1 | <0.5 | <0.5 | <0.5 |
| (mm) | | | | | |
| T Range^{c} | 55 | 55 | 55 | 50 | 55 |
| (° C.) | (285-230) | (290-235) | (285-230) | (290-240) | (285-230) |

^{a}Values determined according to ISO 180: 2000 method U (ISO 180/U, unnotched Izod).
^{b}Values obtained using curl bar test.
^{c}Values obtained using temperature range test; maximum to minimum temperature of the range in parentheses; T range is temperature range.

1. A 3D printed article comprising:
A) 100 to 30 weight percent of a polyamide composition comprising:
a) 95 to 5 weight percent of at least one semi-crystalline copolyamide having a melting point, said semi-crystalline copolyamide comprising:
i) 5 to 40 mole percent aromatic repeat units derived from one or more aromatic dicarboxylic acids with 8 to 20 carbon atoms and at least one aliphatic diamine with 4 to 20 carbon atoms; and
ii) 60 to 95 mole percent aliphatic repeat units derived from one or more aliphatic dicarboxylic acids with 6 to 20 carbon atoms and one or more aliphatic diamines with 4 to 20 carbon atoms;
b) 5 to 95 weight percent of at least one amorphous copolyamide comprising:
iii) 60 to 90 mole percent aromatic repeat units derived from isophthalic acid and at least one aliphatic diamine with 4 to 20 carbon atoms; and
iv) 10 to 40 mole percent aromatic repeat units derived from terephthalic acid and at least one aliphatic diamine with 4 to 20 carbon atoms;
wherein the weight percent of (a) and (b) total 100 weight percent of polyamide composition (A); and
B) 0 to 70 weight percent of at least one additive; and
wherein the weight percent of (A) and (B) total 100 weight percent of the 3D printed article.

2. The 3D printed article of claim 1 wherein semi-crystalline copolyamide (a) is selected from the group consisting of PA 66/6T, PA 610/6T, PA 612/6T, PA 614/6T, PA 616/6T, and PA 618/6T.

3. The 3D printed article of claim 1 wherein amorphous copolyamide (b) is PA 6I/6T.

4. A 3D printed article comprising:
A) 99 to 30 weight percent of a polyamide composition comprising:
a) 85 to 65 weight percent of at least one semi-crystalline copolyamide having a melting point, said semi-crystalline copolyamide comprising:
i) 5 to 40 mole percent aromatic repeat units derived from one or more aromatic dicarboxylic acids with 8 to 20 carbon atoms and at least one aliphatic diamine with 4 to 20 carbon atoms; and
ii) 60 to 95 mole percent aliphatic repeat units derived from one or more aliphatic dicarboxylic acids with 6 to 20 carbon atoms and one or more aliphatic diamines with 4 to 20 carbon atoms;
b) 15 to 35 weight percent of at least one amorphous copolyamide comprising:
iii) 60 to 90 mole percent aromatic repeat units derived from isophthalic acid and at least one aliphatic diamine with 4 to 20 carbon atoms; and
iv) 10 to 40 mole percent aromatic repeat units derived from terephthalic acid and at least one aliphatic diamine with 4 to 20 carbon atoms;
wherein the weight percent of (a) and (b) total 100 weight percent of polyamide composition (A); and
B) 1 to 70 weight percent of at least one additive; and
wherein the weight percent of (A) and (B) total 100 weight percent of the 3D printed article.

5. The 3D printed article of claim 4 wherein additive (B) is selected from the group consisting of reinforcing agents, tougheners, fillers, adhesion promoters, compatibilizers, crystallization accelerators, crystallization retarders, flow aids, lubricants, mold-release agents, colorants, plasticizers, antioxidants, heat stabilizers, processing aids, flame retardants, antistatic agents, high temperature copolyamides, aliphatic polyamides, and combinations of these.

6. The 3D printed article of claim 5 wherein said reinforcing agent is selected from the group consisting of glass fibers, glass beads, carbon fibers, graphite, and combinations of these.

7. The 3D printed article of claim 5 wherein said toughener is selected from the group consisting of functionalized polymeric tougheners, nonfunctionalized polymeric tougheners, and mixtures of these.

8. The 3D printed article of claim 4 wherein the ratio of wet:dry tensile moduli of elasticity, as measured at room temperature, is greater than or equal to 0.85 and the ratio of wet:dry maximum tensile strength is greater than or equal to 0.85.

9. The 3D printed article of claim 1 which is prepared by a material extrusion additive manufacturing process.

10. The 3D printed article of claim 4 exhibiting a ratio of vertical:flat tensile strength of greater than or equal to 0.5.

11. The 3D printed article of claim 1 which, when tested according to the Curl Bar Test, exhibits a height displacement of 1 mm or less.

12. The 3D printed article of claim 1 which, when tested according to the Curl Bar Test, exhibits a height displacement of 0.5 mm or less.

13. An additive manufacturing composition comprising:
A) 100 to 30 weight percent of a polyamide composition comprising:
a) 95 to 5 weight percent of at least one semi-crystalline copolyamide having a melting point, said semi-crystalline copolyamide comprising:
i) 5 to 40 mole percent aromatic repeat units derived from one or more aromatic dicarboxylic acids with 8 to 20 carbon atoms and at least one aliphatic diamine with 4 to 20 carbon atoms; and
ii) 60 to 95 mole percent aliphatic repeat units derived from one or more aliphatic dicarboxylic acids with 6 to 20 carbon atoms and one or more aliphatic diamines with 4 to 20 carbon atoms;
b) 5 to 95 weight percent of at least one amorphous copolyamide comprising:
iii) 60 to 90 mole percent aromatic repeat units derived from isophthalic acid and at least one aliphatic diamine with 4 to 20 carbon atoms; and
iv) 10 to 40 mole percent aromatic repeat units derived from terephthalic acid and at least one aliphatic diamine with 4 to 20 carbon atoms;
wherein the weight percent of (a) and (b) total 100 weight percent of polyamide composition (A); and
B) 0 to 70 weight percent of at least one additive; and
wherein the weight percent of (A) and (B) total 100 weight percent of the additive manufacturing composition.

14. The composition of claim 13 in the form of filaments or pellets.

15. The 3D printed article of claim 4 wherein semi-crystalline copolyamide (a) is selected from the group consisting of PA 66/6T, PA 610/6T, PA 612/6T, PA 614/6T, PA 616/6T, and PA 618/6T.

16. The 3D printed article of claim 4 wherein amorphous copolyamide (b) is PA 6I/6T.

17. The 3D printed article of claim 9 wherein the material extrusion additive manufacturing process is a fused filament fabrication process.

18. The 3D printed article of claim 9 wherein the material extrusion additive manufacturing process is a pellet additive manufacturing process.

19. The 3D printed article of claim 4 wherein polyamide composition (A) comprises:
a) 5 to 54 weight percent of at least one semi-crystalline copolyamide having a melting point, said semi-crystalline copolyamide comprising:
i) 5 to 40 mole percent aromatic repeat units derived from one or more aromatic dicarboxylic acids with 8 to 20 carbon atoms and at least one aliphatic diamine with 4 to 20 carbon atoms; and
ii) 60 to 95 mole percent aliphatic repeat units derived from one or more aliphatic dicarboxylic acids with 6 to 20 carbon atoms and one or more aliphatic diamines with 4 to 20 carbon atoms;
b) 46 to 95 weight percent of at least one amorphous copolyamide comprising:
iii) 60 to 90 mole percent aromatic repeat units derived from isophthalic acid and at least one aliphatic diamine with 4 to 20 carbon atoms; and
iv) 10 to 40 mole percent aromatic repeat units derived from terephthalic acid and at least one aliphatic diamine with 4 to 20 carbon atoms;
wherein the weight percent of (a) and (b) total 100 weight percent of polyamide composition (A).
